(19) United States
(12) Patent Application Publication
(10) Pub. No.: US 2026/0291381 A1
(43) Pub. Date: Sep. 24, 2026

(54) MULTI-OUTPUT VOLTAGE CONVERTER

(71) Applicant: Samsung Electronics Co., Ltd., Suwon-si (KR)

(72) Inventors: Bonggeun Chung, Suwon-si (KR); Yongjin Kwon, Suwon-si (KR); Hocheol Noh, Suwon-si (KR); Jaehyun Park, Suwon-si (KR); Donghee Cho, Suwon-si (KR); Taesung Kim, Suwon-si (KR)

(21) Appl. No.: 19/330,278

(22) Filed: Sep. 16, 2025

(30) Foreign Application Priority Data
Mar. 24, 2025 (KR) 10-2025-0037244

(51) Int. Cl. H02M 1/44; H02M 1/00; H02M 1/088; H02M 3/157; H02M 3/158

(52) U.S. Cl. CPC H02M 1/44; H02M 1/009; H02M 1/088; H02M 3/157; H02M 3/158; H02M 1/0025

(57) ABSTRACT

A multi-output voltage converter includes a first converting circuit, a second converting circuit, a strength adjusting signal generator, a first driving circuit and a second driving circuit. The first converting circuit includes a first power transistor and generates a first output voltage by converting an input voltage based on a first driving signal. The second converting circuit includes a second power transistor, and generates a second output voltage by converting the input voltage based on a second driving signal. The strength adjusting signal generator generates a strength adjusting signal based on transition timings of first and second internal driving signals. Each of the first driving circuit and the second driving circuit reduces a driving strength of the first driving signal and the second driving signal based on the strength adjusting signal when the first transition timing is synchronized with the second transition timing.

### CROSS-REFERENCE TO RELATED APPLICATION

This U.S. application claims priority under 35 USC § 119 to Korean Patent Application No. 10-2025-0037244, filed on Mar. 24, 2025, in the Korean Intellectual Property Office (KIPO), the disclosure of which is incorporated herein by reference in its entirety.

### BACKGROUND

### 1. Technical Field

Example embodiments relate generally to semiconductor integrated circuits, and more particularly to a multi-output voltage converter.

### 2. Discussion of the Related Art

A voltage converter, which converts high direct current (DC) voltage to low DC voltage, may be used to provide power to electronic devices. The voltage converter may be included in various devices and systems such as mobile devices, electric motor vehicles, etc.

The voltage converter may be designed to have high performance and high efficiency. The voltage converter may include a buck converter to step down a voltage level, a boost converter to step-up a voltage level and a buck-boot converter to step down or step up a voltage level. For example, when the voltage converter is employed in the mobile device, in which the voltage converter may charge its battery rapidly by converting a high DC voltage to a low DC voltage with high efficiency. In a multi-output voltage converter, simultaneous switching operations may lead to excessive power supply noise due to abrupt current influxes which may compromise the operating efficiency of the voltage converter.

### SUMMARY

Some example embodiments may provide multi-output voltage converter capable of reducing noise when power transistors are simultaneously turned-on or turned-off.

According to example embodiments, a multi-output voltage converter includes a first converting circuit configured to generate a first output voltage by converting an input voltage, the first converting circuit including a first power transistor configured to pull-up a first switching node based on a first driving signal, a second converting circuit configured to generate a second output voltage by converting the input voltage, the second converting circuit including a second power transistor configured to pull-up a second switching node based on a second driving signal, a strength adjusting signal generator configured to generate a strength adjusting signal based on a first transition timing of a first internal driving signal and a second transition timing of a second internal driving signal, a first driving circuit configured to generate the first driving signal which dynamically adjusts a driving strength of the first power transistor based on the strength adjusting signal and the first internal driving signal, a second driving circuit configured to generate the second driving signal which dynamically adjusts a driving strength of the second power transistor based on the strength adjusting signal and the second internal driving signal, wherein the strength adjusting signal indicates that the second transition timing of the second internal driving signal is simultaneous with the first transition timing of the first internal driving signal.

According to example embodiments, a multi-output voltage converter includes a plurality of converting circuits, each of the plurality of converting circuits including a inductor and a power transistor and configured to generate a output voltage at a respective output node by converting an input voltage based on a respective driving signal, each power transistor of the plurality of converting circuits configured to pull-up a respective switching node based on the respective driving signal, each switching node of the plurality of converting circuits being coupled to a first end of the respective inductor, a strength adjusting signal generator configured to generate a plurality of strength adjusting signals based on transition timings of a plurality of internal driving signals including a first internal driving signal and a second internal driving signal, and a plurality of driving circuits including a first driving circuit and a second driving circuit, the first and second driving circuits configured to generate a first driving signal and a second driving signal based on a first internal driving signal and a second internal driving signal, wherein the first driving signal drives a first power transistor and the second driving signal drives a second power transistor, wherein, upon detecting that a first transition timing of the first internal driving signal is simultaneous with a second transition timing of the second internal driving signal, each of the first driving circuit associated with a first driving signal and the second driving circuit associated with a second driving signal is configured to reduce a driving strength of a respective one of the first power transistor and the second power transistor, based on the first internal driving signal, the second internal driving signal and a first strength adjusting signal indicating that the first transition timing is simultaneous with the second transition timing.

According to example embodiments, a multi-output voltage converter includes a first converting circuit including a first inductor and a first power transistor, the first converting circuit configured to generate a first output voltage at a first output node by converting an input voltage based on a first driving signal, the first power transistor configured to pull-up a first switching node coupled to a first end of the first inductor based on the first driving signal, a second converting circuit including a second inductor and a second power transistor, the second converting circuit configured to generate a second output voltage at a second output node by converting the input voltage based on a second driving signal, the second power transistor configured to pull-up a second switching node coupled to a first end of the second inductor based on the second driving signal, a shifting signal generator configured to generate a shifting signal based on a first transition timing of a first internal driving signal and a second transition timing of a second internal driving signal, a first driving circuit configured to generate the first driving signal based on the first internal driving signal, and a second driving circuit configured to generate the second driving signal by shifting the second transition timing of the second internal driving signal based on the shifting signal indicating that the first transition timing is simultaneous with the second transition timing.

According to example embodiments, there is provided a method of operating a multi-output voltage converter that includes a first driving circuit, a second driving circuit, a first converting circuit, a second converting circuit and a strength adjusting signal generator. According to the method, it is determined, by the strength adjusting signal generator, whether a first internal driving signal and a second internal driving signal are simultaneously activated, based on a determination that first internal driving signal and the second internal driving signal are simultaneously activated, respective one of a first driving signal and a second driving signal is generated by reducing a driving strength of respective one of the first internal driving signal and the second internal driving signal based on the strength adjusting signal, respective one of the first driving signal and the second driving signal is applied to respective one of high-side switches of the first converting circuit and the second converting circuit, based on a determination that first internal driving signal and the second internal driving signal are not simultaneously activated, respective one of a first driving signal and a second driving signal is generated by maintaining a driving strength of respective one of the first internal driving signal and the second internal driving signal based on the strength adjusting signal, respective one of the first driving signal and the second driving signal is applied to respective one of high-side switches of the first converting circuit and the second converting circuit.

In the multi-output voltage converter according to example embodiments, when the first transition timing of the first internal driving signal is synchronized with the second transition timing of the second internal driving signal and the first power transistor and the second power transistor are simultaneously turned-on or simultaneously turned-off, each driving strength of the first power transistor and the second power transistor is reduced. Accordingly, a ground noise generated at the ground node of the multi-output voltage converter may be reduced and a switching loss may be reduced.

### BRIEF DESCRIPTION OF THE DRAWINGS

Example embodiments of the present disclosure will be more clearly understood from the following detailed description taken in conjunction with the accompanying drawings.

FIG. 1 is a block diagram illustrating an example of a multi-output voltage converter according to example embodiments.

FIG. 2 is a circuit diagram illustrating an example of the first driving circuit in the multi-output voltage converter of FIG. 1 according to example embodiments.

FIG. 3 is a circuit diagram illustrating an example of the second driving circuit in the multi-output voltage converter of FIG. 1 according to example embodiments.

FIG. 4 is a table illustrating signals associated with the first driving circuit of FIG. 2 according to example embodiments.

FIG. 5A is a circuit diagram illustrating an example of the SAS generator in the multi-output voltage converter of FIG. 1 according to example embodiments.

FIG. 5B is a circuit diagram illustrating an example of the SAS generator in the multi-output voltage converter of FIG. 1 according to example embodiments.

FIG. 6A is a timing diagram illustrating an operation of the SAS generator of FIG. 5A according to example embodiments.

FIG. 6B is a timing diagram illustrating an operation of the SAS generator of FIG. 5B according to example embodiments.

FIG. 7 is a block diagram illustrating an example of the control circuit in the multi-output voltage converter of FIG. 1 according to example embodiments.

FIG. 8 is a timing diagram illustrating an operation of the SAS generator of FIG. 5A according to example embodiments.

FIG. 9 is a timing diagram illustrating an operation of the SAS generator of FIG. 5A according to example embodiments.

FIG. 10A is a timing diagram illustrating an example operation of the multi-output voltage converter 10a of FIG. 1 according to example embodiments.

FIG. 10B is a timing diagram illustrating an example operation of the multi-output voltage converter 10a of FIG. 1 according to example embodiments.

FIG. 11A is a timing diagram illustrating an example operation of the multi-output voltage converter of FIG. 1 when the multi-output voltage converter does not generate the strength adjusting signal.

FIG. 11B is a timing diagram illustrating an example operation of the multi-output voltage converter of FIG. 1 when the multi-output voltage converter does not generate the strength adjusting signal.

FIG. 12 is a block diagram illustrating an example of a multi-output voltage converter according to example embodiments.

FIG. 13 is a block diagram illustrating an example of a multi-output voltage converter according to example embodiments.

FIG. 14 is a block diagram illustrating an example of a multi-output voltage converter according to example embodiments.

FIG. 15 is a block diagram illustrating an example of a multi-output voltage converter according to example embodiments.

FIG. 16 is a timing diagram illustrating an example operation of the multi-output voltage converter of FIG. 15 according to example embodiments.

FIG. 17 is a block diagram illustrating an example of a multi-output voltage converter according to example embodiments.

FIG. 18 is a timing diagram illustrating an example operation of the multi-output voltage converter of FIG. 17 according to example embodiments.

FIG. 19 is a flow chart illustrating a method of operating a multi-output voltage converter according to example embodiments.

FIG. 20 is a block diagram illustrating an electronic device including a multi-output voltage converter according to example embodiments.

FIG. 21 is a block diagram illustrating a wireless communication device according to example embodiments.

FIG. 22 is a diagram illustrating a system including a multi-output voltage converter according to example embodiments.

### DETAILED DESCRIPTION OF THE EMBODIMENTS

Various example embodiments will be described more fully hereinafter with reference to the accompanying drawings, in which some example embodiments are shown. In the drawings, like numerals refer to like elements throughout. The repeated descriptions may be omitted.

It will be understood that, although the terms first, second, third etc. may be used herein to describe various elements, and/or components, regions, these elements, and/or components should not be limited by these terms. Unless the context indicates otherwise, these terms are only used to distinguish one element, or component from another element, or component, for example as a naming convention. Thus, a first element, or component discussed below in one section of the specification could be termed a second element, or component in another section of the specification or in the claims without departing from the teachings of the present invention. In addition, in certain cases, even if a term is not described using “first,” “second,” etc., in the specification, it may still be referred to as “first” or “second” in a claim in order to distinguish different claimed elements from each other.

Items described in the singular herein may be provided in plural, as can be seen, for example, in the drawings. Thus, the description of a single item that is provided in plural should be understood to be applicable to the remaining plurality of items unless context indicates otherwise.

Throughout the specification, when a component is described as “including” a particular element or group of elements, it is to be understood that the component is formed of only the element or the group of elements, or the element or group of elements may be combined with additional elements to form the component, unless the context indicates otherwise.

Terms such as “same,” or “equal,” as used herein when referring to shapes, sizes, amounts, or other measures do not necessarily mean an exactly identical shape, size, amount, or other measure, but are intended to encompass nearly identical shapes, sizes, amounts, or other measures within typical variations that may occur resulting from conventional manufacturing processes. The term “substantially” may be used herein to emphasize this meaning, unless the context or other statements indicate otherwise. For example, items described as “substantially the same,” or “substantially equal,” may be exactly the same, or equal, or may be the same, or equal within acceptable variations that may occur, for example, due to manufacturing processes.

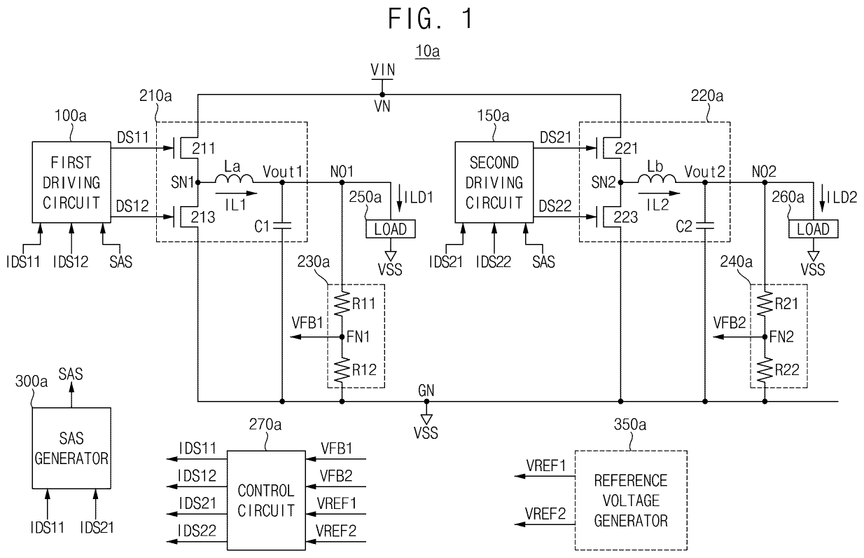

FIG. 1 is a block diagram illustrating an example of a multi-output voltage converter according to example embodiments.

Referring to FIG. 1, a multi-output voltage converter 10a may include a first driving circuit 100a, a second driving circuit 150a, a first converting circuit 210a, a second converting circuit 220a, a first feedback circuit 230a, a second feedback circuit 240a, a control circuit 270a and a strength adjusting signal (SAS) generator 300a. The multi-output voltage converter 10a may further include a reference voltage generator 350a.

In FIG. 1, a load 250a coupled to a first output node NO1 of the multi-output voltage converter 10a and a load 260a coupled to a second output node NO2 of the multi-output voltage converter 10a are also shown for convenience of explanation.

The first converting circuit 210a may be connected between a voltage node VN and a ground node GN and may include a first power transistor 211, a third power transistor 213, a first inductor La and a first capacitor C1. The voltage node VN may be connected to an input voltage VIN, and the ground node GN may be connected to a ground voltage VSS. The first converting circuit 210a may generate a first output voltage Vout1 having a first voltage level at the first output node NO1 by converting voltage level of the input voltage VIN to the first voltage level based on a first driving signal DS11 and a third driving signal DS12. The first voltage level of the first output voltage Vout1 may be smaller than the voltage level of the input voltage VIN.

The first power transistor 211 may be coupled between the input voltage VIN and a first switching node SN1, and may have a gate receiving the first driving signal DS11. The first power transistor 211 may be implemented with an n-channel metal-oxide semiconductor (NMOS) transistor. The third power transistor 213 may be coupled between the first switching node SN1 and the ground voltage VSS, and may have a gate receiving the third driving signal DS12. The third power transistor 213 may be implemented with an NMOS transistor. The first inductor La may be coupled between the first switching node SN1 and the first output node NO1 and the first capacitor C1 may be coupled between the first output node NO1 and the ground voltage VSS.

The first power transistor 211 may be turned-on and pull-up the first switching node SN1 in response to activation of the first driving signal DS11 at a logic high level. The third power transistor 213 may be turned-on and pull-down the first switching node SN1 in response to activation of the third driving signal DS12 at a logic high level. Each of the first and third power transistors 211 and 213 may be a power switch which drives the first output voltage Vout1.

The first inductor La and the first capacitor C1 may operate as a low pass filter and may output the first output voltage Vout1 at the first output node NO1 by filtering out high-frequency components from a voltage at the first switching node SN1. A first indictor current IL1 may flow to the first output node NO1 from the first switching node SN1. The first switching node SN1 may be coupled to a first end of the first inductor La and the first output node NO1 may be coupled to a second end of the first inductor La.

The first feedback circuit 230a may generate a first feedback voltage VFB1 proportional to the first output voltage Vout1 and may provide the first feedback voltage VFB1 to the control circuit 270a. The first feedback circuit 230a, as illustrated in FIG. 1, may generate the first feedback voltage VFB1 corresponding to the ratio of the resistance values of voltage division resistors R11 and R12.

The voltage division resistors R11 and R12 may be connected in series between the first output node NO1 and the ground voltage VSS and may be connected to each other at a first feedback node FN1. The first feedback circuit 230a may output the first feedback voltage VFB1 at the first feedback node FN1.

The second converting circuit 220a may be connected between the voltage node VN and the ground node GN and may include a second power transistor 221, a fourth power transistor 223, a second inductor Lb and a second capacitor C2. The second converting circuit 220a may generate a second output voltage Vout2 at a second output node NO2 by converting the input voltage VIN based on a second driving signal DS21 and a fourth driving signal DS22.

The second power transistor 221 may be coupled between the input voltage VIN and a second switching node SN2, and may have a gate receiving the second driving signal DS21. The second power transistor 221 may be implemented with an NMOS transistor. The fourth power transistor 223 may be coupled between the second switching node SN2 and the ground voltage VSS, and may have a gate receiving the fourth driving signal DS22. The power transistor 223 may be implemented with an NMOS transistor. The second inductor Lb may be coupled between the second switching node SN2 and the second output node NO2 and the second capacitor C2 may be coupled between the second output node NO2 and the ground voltage VSS.

The second power transistor 221 may be turned-on and pull-up the second switching node SN2 in response to activation of the second driving signal DS21 at a logic high level. The fourth power transistor 223 may be turned-on and pull-down the second switching node SN2 in response to activation of the fourth driving signal DS22 with a logic high level. Each of the second and fourth power transistors 221 and 223 may be a power switch which drives the second output voltage Vout2.

The second inductor Lb and the second capacitor C2 may operate as a low pass filter and may output the second output voltage Vout2 at the second output node NO2 by filtering out high-frequency components from a voltage at the second switching node SN2. A second indictor current IL2 may flow to the second output node NO2 from the second switching node SN2. The second switching node SN2 may be coupled to a first end of the second inductor Lb and the second output node NO2 may be coupled to a second end of the second inductor Lb.

The second feedback circuit 240a may generate a second feedback voltage VFB2 proportional to the second output voltage Vout2 and may provide the second feedback voltage VFB2 to the control circuit 270a. The second feedback circuit 240a, as illustrated in FIG. 1, may generate the second feedback voltage VFB2 corresponding to the ratio of the resistance values of voltage division resistors R21 and R22.

The voltage division resistors R21 and R22 may be connected in series between the second output node NO2 and the ground voltage VSS and may be connected to each other at a second feedback node FN2. The second feedback circuit 240a may output the second feedback voltage VFB2 at the second feedback node FN2.

A first load current ILD1 may flow into the load 250a based on the first output voltage Vout1 and a second load current ILD2 may flow into the load 260a based on the second output voltage Vout2.

The first driving circuit 100a, the first converting circuit 210a and the first feedback circuit 230a may constitute a first buck converter and the driving circuit 150a, the second converting circuit 220a and the second feedback circuit 240a may constitute a second buck converter.

The reference voltage generator 350a may generate a first reference voltage VREF1 and a second reference voltage VREF2 and may provide the first reference voltage VREF1 and the second reference voltage VREF2 to the control circuit 270a.

The control circuit 270a may receive the first feedback voltage VFB1, the second feedback voltage VFB2, the first reference voltage VREF1 and the second reference voltage VREF2, may generate a first internal driving signal IDS11 and a third internal driving signal IDS12 by comparing the first feedback voltage VFB1 with the first reference voltage VREF1 and may generate a second internal driving signal IDS21 and a fourth internal driving signal IDS22 by comparing the second feedback voltage VFB2 with the second reference voltage VREF2. The first driving circuit 100a may generate the first driving signal DS11 based on the first internal driving signal IDS11, and the third driving signal DS12 based on the third internal driving signal IDS12. The second driving circuit 150a may generate the second driving signal DS21 based on the second internal driving signal IDS21, and the fourth driving signal DS22 based on the fourth internal driving signal IDS22.

The control circuit 270a may provide the first internal driving signal IDS11 and the third internal driving signal IDS12 to the first driving circuit 100a, may provide the second internal driving signal IDS21 and the fourth internal driving signal IDS22 to the second driving circuit 150a and may provide the first internal driving signal IDS11 and the second internal driving signal IDS21 to the SAS generator 300a.

The SAS generator 300a may receive the first internal driving signal IDS11 and the second internal driving signal IDS21, may monitor a first transition timing of the first internal driving signal IDS11 and a second transition timing of the second internal driving signal IDS21, may generate a strength adjusting signal SAS based on the first transition timing of the first internal driving signal IDS11 being synchronized with the second transition timing of the second internal driving signal IDS21 and may provide the strength adjusting signal SAS to the first driving circuit 100a and the second driving circuit 150a. The strength adjusting signal SAS may transition to a first logic level (e.g., a logic low level) when the first transition timing of the first internal driving signal IDS11 and the second transition timing of the second internal driving signal IDS21 are simultaneous. The SAS generator 300a may generate the strength adjusting signal SAS having the first logic level upon detecting that the first transition timing of the first internal driving signal IDS11 is substantially simultaneous with the second transition timing of the second internal driving signal IDS21.

The transition timing may include an activation timing of each of the first internal driving signal IDS11 and the second internal driving signal IDS21 and a deactivation timing of each of the first internal driving signal IDS11 and the second internal driving signal IDS21. For example, the first transition timing may include a first activation timing or a first deactivation timing of the first internal driving signal IDS11 and the second transition timing may include a second activation timing or a second deactivation timing of the second internal driving signal IDS21. Accordingly, simultaneous transitioning of the first internal driving signal IDS11 and the second internal driving signal IDS21 may indicate that the first activation timing of the first internal driving signal IDS11 and the second activation timing of the second internal driving signal IDS21 occur at the same time, or the first deactivation timing of the first internal driving signal IDS11 and the second deactivation timing of the second internal driving signal IDS21 occur at the same time.

The first driving circuit 100a may generate the first driving signal DS11 based on the first internal driving signal IDS11, may generate the third driving signal DS12 based on the third internal driving signal IDS12, and may dynamically adjust a driving strength of the first power transistor 211 by controlling a signal slope of the first driving signal DS11 based on the strength adjusting signal SAS and the first internal driving signal IDS11. When the strength-adjusting signal SAS indicates that the first transition timing of the first internal driving signal IDS11 is simultaneous with the second transition timing of the second internal driving signal IDS21, the slope of the first driving signal DS11 at the gate of the first power transistor 211 becomes less steep, resulting in a reduction of the driving strength of the first power transistor 211.

For example, based on the strength adjusting signal SAS indicating that the first transition timing of the first internal driving signal IDS11 is synchronized (e.g., simultaneous) with the second transition timing of the second internal driving signal IDS21, the first driving circuit 100a may reduce the driving strength of the first power transistor 211 based on the strength adjusting signal SAS and the first internal driving signal IDS11. Based on the strength adjusting signal SAS indicating that the first transition timing of the first internal driving signal IDS11 is not simultaneous with the second transition timing of the second internal driving signal IDS21, the first driving circuit 100a may maintain the normal driving strength of the first power transistor 211 by controlling a signal slope of the first driving signal DS11 based on the strength adjusting signal SAS and the first internal driving signal IDS11.

The second driving circuit 150a may generate the second driving signal DS21 based on the second internal driving signal IDS21, may generate the fourth driving signal DS22 based on the fourth internal driving signal IDS22, and may dynamically reduce a driving strength of the second power transistor 221 by controlling a signal slope of the second driving signal DS21 based on the strength adjusting signal SAS and the second internal driving signal IDS21.

When the strength adjusting signal SAS indicates that the first transition timing of the first internal driving signal IDS11 is simultaneous with the second transition timing of the second internal driving signal IDS21, the second driving circuit 150a may reduce the driving strength of the second power transistor 221by controlling a signal slope of the second driving signal DS21 based on the strength adjusting signal SAS and the second internal driving signal IDS21. When the strength adjusting signal SAS indicates that the first transition timing of the first internal driving signal IDS11 is not simultaneous with the second transition timing of the second internal driving signal IDS21, the second driving circuit 150a may maintain the normal driving strength of the second power transistor 221 by controlling a signal slope of the second driving signal DS21 based on the strength adjusting signal SAS and the second internal driving signal IDS21.

Therefore, when the first transition timing of the first internal driving signal IDS11 is simultaneous with the second transition timing of the second internal driving signal IDS21 and the first power transistor 211 and the second power transistor 221 are simultaneously turned-on or simultaneously turned-off, each driving strength of the first power transistor 211 and the second power transistor 221 may be reduced. Accordingly, a ground power noise generated at the ground node GN of the multi-output voltage converter 10a may be reduced, leading to overall reduction in switching loss of the multi-output voltage converter.

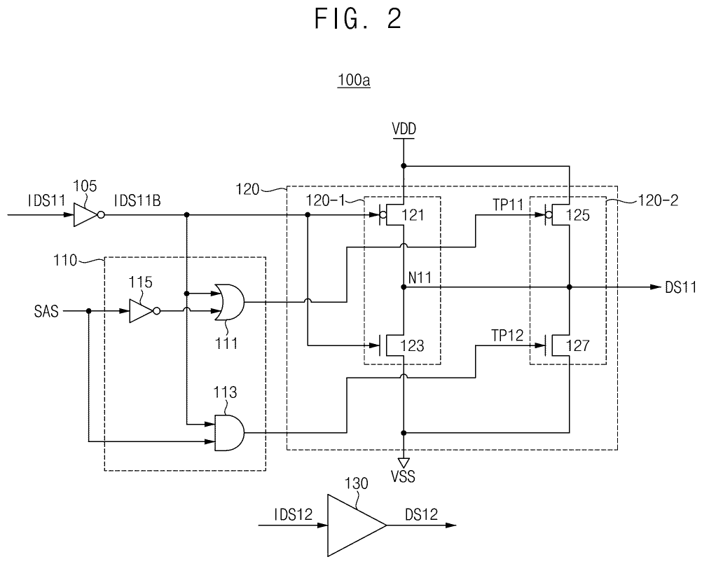

FIG. 2 is a circuit diagram illustrating an example of the first driving circuit in the multi-output voltage converter of FIG. 1 according to example embodiments.

Referring to FIG. 2, the first driving circuit 100a may include a first inverter 105, a logic circuit 110, a gate driver 120 and a buffer 130.

The buffer 130 may generate the third driving signal DS12 by buffering the third internal driving signal IDS12. The first inverter 105 may output a first inverted internal driving signal IDS11B by inverting the first internal driving signal IDS11. The gate driver 120 may include a first driver 120-1 and a second driver 120-2.

The gate driver 120 may adjust the driving strength of the first power transistor 211 either by activating both the first driver 120-1 and the second driver 120-2 or by activating the first driver 120-1 and deactivating the second driver 120-2, thus controlling a slope of the first driving signal DS11 by charging or discharging a first node N11 at which the first driving signal DS11 is provided, based on the first inverted internal driving signal IDS11B, a first control signal TP11 and a second control signal TP12. When both the first driver 120-1 and the second driver 120-2 are activated, the gate driver 120 may maintain normal driving strength of the first power transistor 211, and when the first driver 120-1 is activated and the second driver 120-2 is deactivated, the gate driver 120 may reduce driving strength of the first power transistor 211.

The gate driver 120 may include a first p-channel metal-oxide semiconductor (PMOS) transistor 121, a first NMOS transistor 123, a second PMOS transistor 125 and a second NMOS transistor 127. The first PMOS transistor 121 and the first NMOS transistor 123 may form the first driver 120-1, and a second PMOS transistor 125 and a second NMOS transistor 127 may form the second driver 120-2.

The first PMOS transistor 121 may be coupled between a power supply voltage VDD and the first node N11 and may have a gate receiving the first inverted internal driving signal IDS11B. The first NMOS transistor 123 may be coupled between the first node N11 and the ground voltage VSS and may have a gate receiving the first inverted internal driving signal IDS11B. The second PMOS transistor 125 may be coupled between the power supply voltage VDD and the first node N11 in parallel with the first PMOS transistor 121 and may have a gate to receiving the first control signal TP11. The second NMOS transistor 127 may be coupled between the first node N11 and the ground voltage VSS in parallel with the first NMOS transistor 123 and may have a gate receiving the second control signal TP12.

The logic circuit 110 may generate the first control signal TP11 and the second control signal TP12 based on the first inverted internal driving signal IDS11B and the strength adjusting signal SAS.

The logic circuit 110 may include an OR gate 111, an AND gate 113 and a second inverter 115.

The second inverter 115 may invert the strength adjusting signal SAS. The OR gate may generate the first control signal TP11 by performing an OR operation on the first inverted internal driving signal IDS11B and an output of the second inverter 115. The AND gate 113 may generate the second control signal TP12 by performing an AND operation on the first inverted internal driving signal IDS11B and the strength adjusting signal SAS.

For example, in response to the strength adjusting signal SAS having a logic low level, the first control signal TP11 may have a logic high level without regard to a logic level of the first inverted internal driving signal IDS11B and the second control signal TP12 may have a low level without regard to a logic level of the first inverted internal driving signal IDS11B. In this case, the second driver 120-2 may be deactivated, and thus the second PMOS transistor 125 may be turned-off based on the first control signal TP11 regardless of the input logic level of the first inverted internal driving signal IDS11B, and the second NMOS transistor 127 may be turned-off based on the second control signal TP12 regardless of the input logic level of the first inverted internal driving signal IDS11B. Therefore, the second PMOS transistor 125 does not charge the first node N11, the second NMOS transistor 127 does not discharge the first node N11 and the first driving signal DS11 may transition relatively slowly ta the first node N11. On the contrary, when both the second PMOS transistor 125 and the second NMOS transistor 127 are activated and drive the first node N11 in response to logic level of the first inverted internal driving signal IDS11B, the first driving signal DS11 may transition relatively rapidly.

For example, in response to the strength adjusting signal SAS having a logic high level, each of the first control signal TP11 and the second control signal TP12 may have the same logic level as the logic level of the first inverted internal driving signal IDS11B. Accordingly, the normal driving strength of the first power transistor 211 driven by the first driving signal DS11 may remain normal because the second driver 120-2 may be activated to charge or discharge the first node N11 based on a logic level of the first internal driving signal IDS11 or the first inverted internal driving signal IDS11B.

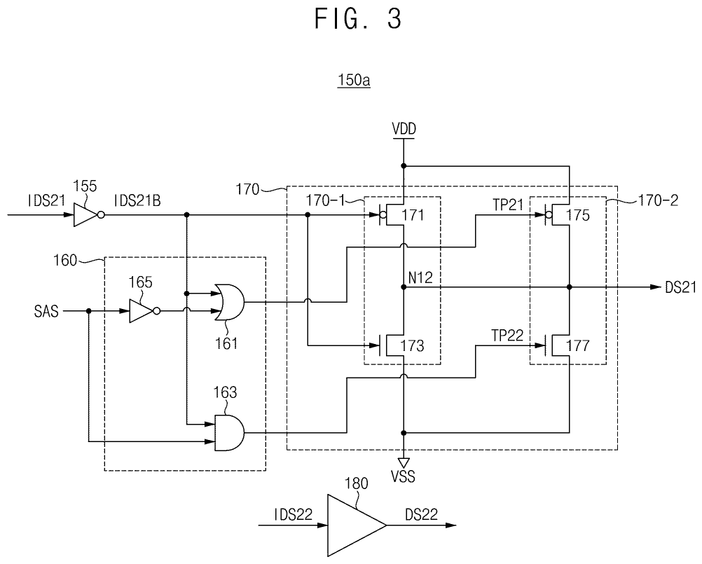

FIG. 3 is a circuit diagram illustrating an example of the second driving circuit in the multi-output voltage converter of FIG. 1 according to example embodiments.

Referring to FIG. 3, the second driving circuit 150a may include a first inverter 155, a logic circuit 160, a gate driver 170 and a buffer 180.

The buffer 180 may generate the fourth driving signal DS22 by buffering the fourth internal driving signal IDS22. The first inverter 155 may output a second inverted internal driving signal IDS21B by inverting the second internal driving signal IDS21. The gate driver 170 may include a third driver 170-1 and a fourth driver 170-2.

The gate driver 170 may adjust the driving strength of the second power transistor 221 either by activating both the third driver 170-1 and the fourth driver 120-2 or by activating the third driver 170-1 and deactivating the fourth driver 170-2, thus controlling a slope of the second driving signal DS11 by charging or discharging a second node N12 at which the second driving signal DS21 is provided, based on the second inverted internal driving signal IDS21B, a third control signal TP21 and a fourth control signal TP22. When both the third driver 170-1 and the fourth driver 170-2 are activated, the gate driver 120 may maintain normal driving strength of the second power transistor 221, and when the third driver 170-1 is activated and the fourth driver 170-2 is deactivated, the gate driver 120 may reduce driving strength of the second power transistor 221.

The gate driver 170 may include a first PMOS transistor 171, a first NMOS transistor 173, a second PMOS transistor 175 and a second NMOS transistor 177. The first PMOS transistor 171 and the first NMOS transistor 173 may form the third driver 170-1, and a second PMOS transistor 175 and a second NMOS transistor 177 may form the fourth driver 170-2.

The first PMOS transistor 171 may be coupled between the power supply voltage VDD and the second node N12 and may have a gate receiving the second inverted internal driving signal IDS21B. The first NMOS transistor 173 may be coupled between the second node N21 and the ground voltage VSS and may have a gate receiving the second inverted internal driving signal IDS21B. The second PMOS transistor 175 may be coupled between the power supply voltage VDD and the second node N12 in parallel with the first PMOS transistor 171 and may have a gate to receiving the third control signal TP21. The second NMOS transistor 177 may be coupled between the second node N12 and the ground voltage VSS in parallel with the first NMOS transistor 173 and may have a gate receiving the fourth control signal TP22.

The logic circuit 160 may generate the third control signal TP21 and the fourth control signal TP22 based on the second inverted internal driving signal IDS21B and the strength adjusting signal SAS.

The logic circuit 160 may include an OR gate 161, an AND gate 163 and a second inverter 165.

The second inverter 165 may invert the strength adjusting signal SAS. The OR gate may generate the third control signal TP21 by performing an OR operation on the second inverted internal driving signal IDS21B and an output of the second inverter 165. The AND gate 163 may generate the fourth control signal TP22 by performing an AND operation on the second inverted internal driving signal IDS21B and the strength adjusting signal SAS.

For example, in response to the strength adjusting signal SAS having a logic low level, the third control signal TP21 may have a logic high level without regard to a logic level of the second inverted internal driving signal IDS21B and the fourth control signal TP22 may have a low level without regard to a logic level of the second inverted internal driving signal IDS21B. In this case, the fourth driver 170-2 may be deactivated, and thus the second PMOS transistor 175 may be turned-off based on the third control signal TP21 and the second NMOS transistor 177 may be turned-off based on the fourth control signal TP22 regardless of the input logic level of the second inverted internal driving signal IDS21B. Therefore, the second PMOS transistor 175 does not charge the second node N12, the second NMOS transistor 177 does not discharge the second node N12 and the second driving signal DS21 may transition relatively slowly at the second node N12. On the contrary, when both the second PMOS transistor 175 and the second NMOS transistor 177 are activated and drive the second node N12 in response to logic level of the second inverted internal driving signal IDS21B, the second driving signal DS21 may transition relatively rapidly.

For example, in response to the strength adjusting signal SAS having a logic high level, each of the third control signal TP21 and the fourth control signal TP22 may have the same logic level as a logic level of the second inverted internal driving signal IDS21B. Accordingly, the normal driving strength of the second power transistor 221 driven by the second driving signal DS21 may remain normal because the fourth driver 170-2 may be activated to charge or discharge the second node N12 based on a logic level of the second internal driving signal IDS21 or the second inverted internal driving signal IDS21B.

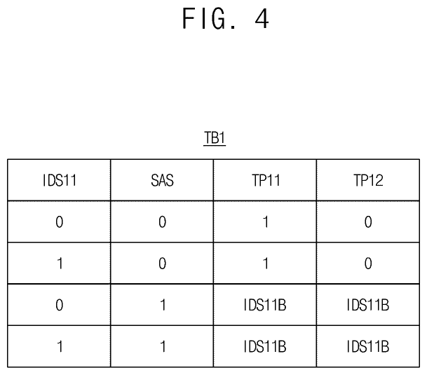

FIG. 4 is a table illustrating signals associated with the first driving circuit of FIG. 2 according to example embodiments.

In a table TB1 of FIG. 4, the logic levels of the first internal driving signal IDS11, the first control signal TP11 and the second control signal TP12 are illustrated related to the logic level of the strength adjusting signal SAS.

Referring to FIGS. 2 and 4, in response to the strength adjusting signal SAS having a logic low level, the first control signal TP11 may have a logic high level without regard to a logic level of the first inverted internal driving signal IDS11B and the second control signal TP12 may have a logic low level without regard to a logic level of the first inverted internal driving signal IDS11B. In response to the strength adjusting signal SAS having a logic high level, each of the first control signal TP11 and the second control signal TP12 may have the same logic level as the logic level of the first inverted internal driving signal IDS11B.

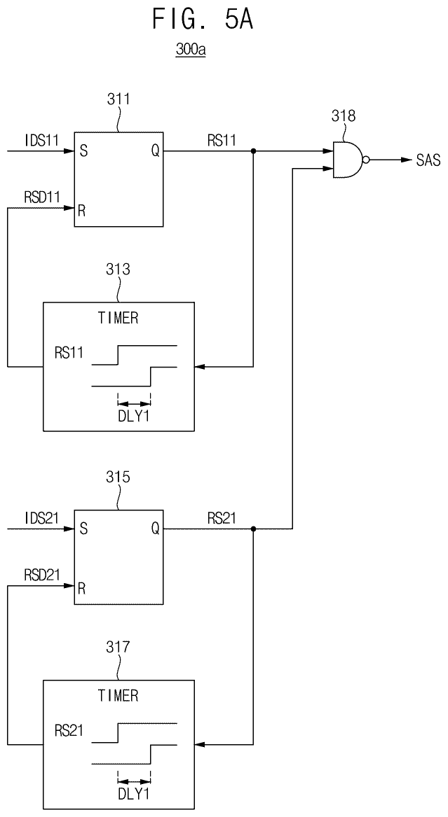

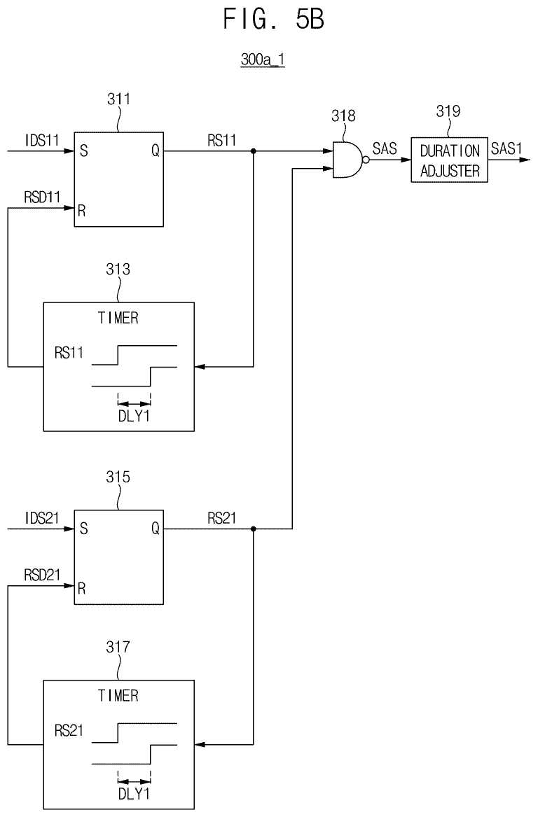

FIG. 5A is a circuit diagram illustrating an example of the SAS generator in the multi-output voltage converter of FIG. 1 according to example embodiments.

Referring to FIG. 5A, the SAS generator 300a may include a first flip-flop 311, a first timer 313, a second flip-flop 315, a second timer 317 and a NAND gate 318.

The first flip-flop 311 may include a set terminal S receiving the first internal driving signal IDS11, a reset terminal R receiving a first delayed latched signal RSD11 and an output terminal Q outputting a first latched signal RS11. The first flip-flop 311 may provide the first latched signal RS11 at the output terminal Q by latching the first internal driving signal IDS11. The first timer 313 may generate the first delayed latched signal RSD11 by delaying the first latched signal RS11 by a first delay time (e.g., a first time delay) DLY1 and may provide the first delayed latched signal RSD11 to the reset terminal R of the first flip-flop 311. Therefore, the first latched signal RS11 may have a pulse shape at a logic high level that has a duration corresponding to the first delay time DLY1 in response to rising of the first internal driving signal IDS11. Accordingly, the first flip-flop 311 may generate the first latched signal RS11 upon detecting rising of the first internal driving signal IDS11, and the first latched signal RS11 may have a duration corresponding to the first delay time DLY1.

The second flip-flop 315 may include a set terminal S receiving the second internal driving signal IDS21, a reset terminal R receiving a second delayed latched signal RSD21 and an output terminal Q outputting a second latched signal RS21. The second flip-flop 315 may provide the second latched signal RS21 at the output terminal Q by latching the second internal driving signal IDS21. The second timer 317 may generate the second delayed latched signal RSD21 by delaying the second latched signal RS21 by a second delay time (e.g., a second time delay) DLY2, which is substantially equal to the first delay time DLY1, and may provide the second delayed latched signal RSD21 to the reset terminal R of the second flip-flop 315. Therefore, the second latched signal RS21 may have a pulse shape at a logic high level that has a duration corresponding to the second delay time DLY2 based on the second internal driving signal IDS11. Accordingly, the second flip-flop 315 may generate the second latched signal RS21 upon detecting the activation of the second internal driving signal IDS21, and the first latched signal RS21 may have a duration corresponding to the second delay time DLY2.

The NAND gate 318 may generate the strength adjusting signal SAS by performing a NAND operation on the first latched signal RS11 and the second latched signal RS21. Accordingly, the NAND gate 318 may generate the strength adjusting signal SAS having a logic low level which corresponds to an overlap between an activation period of the first latched signal RS11 and an activation period of the second latched signal RS21. Specifically, the SAS generator 300a may generate the strength adjusting signal SAS at a logic low level having a third duration based on a first activation time point the first latched signal RS11 a second activation time point of the second latched signal RS21. The third duration may be changed depending on temporal proximity between the first activation time point the first latched signal RS11 and the second activation time point of the second latched signal RS21.

The first and second delay times DLY1 and DLY2 may be adjusted depending on an estimated power supply noise generated when the first power transistor 211 and the second power transistors 221 are simultaneously turned-on or simultaneously turned-off (e.g., settling timing of the noise).

FIG. 5B is a circuit diagram illustrating an example of the SAS generator in the multi-output voltage converter of FIG. 1 according to example embodiments.

Referring to FIG. 5B, an SAS generator 300a_1 may include a first flip-flop 311, a first timer 313, a second flip-flop 315, a second timer 317, a NAND gate 318 and a duration adjuster 319.

In FIG. 5B, descriptions repeated with FIG. 5A will be omitted.

The duration adjuster 319 may generate a first strength adjusting signal SAS1 by adjusting a duration of a logic low level of the strength adjusting signal SAS. The duration during which the first strength adjusting signal SAS1 maintains a logic low level may be adjusted by the duration adjuster 319 depending on the power supply noise generated while the first power transistor 211 and the second power transistors 221 are simultaneously turned-on or simultaneously turned-off.

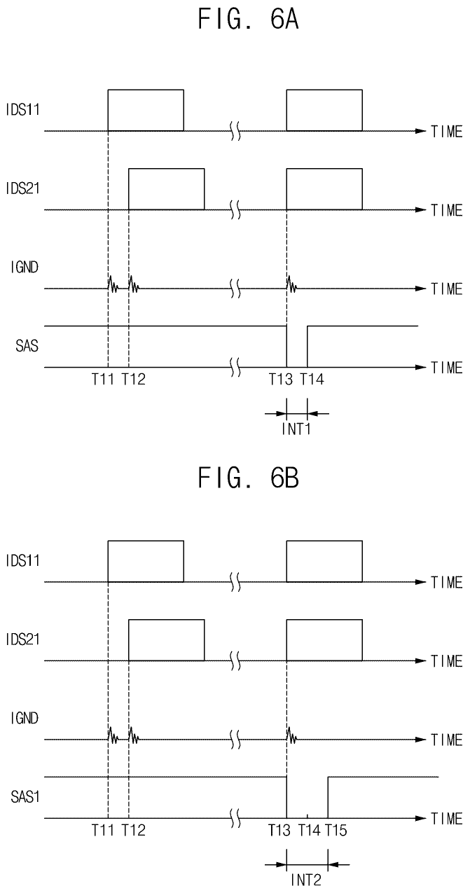

FIG. 6A is a timing diagram illustrating an operation of the SAS generator of FIG. 5A according to example embodiments.

Referring to FIGS. 5A and 6A, when the first internal driving signal IDS11 is activated with a logic high level at a first time point T11 and the first internal driving signal IDS21 is activated with a logic high level at a second time point T12 after the first time point T11, power supply noise generated from operation of the first power transistor 211 and the second power transistors 221 may be distributed because a current IGND flowing into the ground node GN in FIG. 1 is distributed due to the time interval between the first time point T11 and the second time point T12. The strength adjusting signal SAS maintains a logic high level between the first time point T11 and a time point T12.

When the first internal driving signal IDS11 and the second internal driving signal IDS21 are simultaneously received at the time point T13, the strength adjusting signal SAS may have a logic low level during the first time interval INT1 between the time points T13 and T14. Therefore, each driving strength of the first power transistor 211 and the second power transistors 221 driven by each of the first internal driving signal IDS11 and the second internal driving signal IDS21 in FIG. 2 may be reduced and the current IGND flowing into the ground node GN in FIG. 1 at the time point T13 may be also reduced to not be greater than the current IGND flowing into the ground node GN at the time point T11. Accordingly, when the first power transistor 211 and the second power transistor 221 are simultaneously turned-on based on the first internal driving signal IDS11 and the second internal driving signal IDS21 being simultaneously activated, a noise generated at the ground node GN may be reduced.

In FIG. 6A, it is shown that the first power transistor 211 and the second power transistor 221 are simultaneously turned-on. In addition, when the first power transistor 211 and the second power transistor 221 are simultaneously turned-off in response to simultaneous deactivation of the first internal driving signal IDS11 and the second internal driving signal IDS21, the power supply noise generated at the ground node GN may be reduced by adjusting driving strengths of the first power transistor 211 and the second power transistors 221 using the strength adjusting signal SAS.

FIG. 6B is a timing diagram illustrating an operation of the SAS generator of FIG. 5B according to example embodiments.

Referring to FIGS. 5B and 6B, when the first internal driving signal IDS11 is activated with a logic high level at a first time point T11 and the first internal driving signal IDS21 is activated with a logic high level at a second time point T12 after the first time point T11, a power supply noise is generated due to a current IGND flowing into the ground node GN in FIG. 1. The strength adjusting signal SAS is maintained with a logic high level between the first time point T11 and a time point T12.

When the first internal driving signal IDS11 and the second internal driving signal IDS21 are simultaneously activated at the time point T13, the strength adjusting signal SAS has a logic low level during the second time interval INT2 between the time points T13 and T15. Therefore, each driving strength of the first power transistor 211 and the second power transistor 221 driven by each of the first internal driving signal IDS11 and the second internal driving signal IDS21 in FIG. 2 may be reduced and the current IGND flowing into the ground node GN in FIG. 1 at the time point T13 may also be reduced to not be greater than the current IGND flowing into the ground node GN at the time point T11. Accordingly, when the first power transistor 211 and the second power transistor 221 are simultaneously turned-on based on the first internal driving signal IDS11 and the second internal driving signal IDS21 being simultaneously activated, the power supply noise generated at the ground node GN may be reduced.

The second time interval INT2 may be greater than the first time interval INT1 and the second time interval INT2 may be variable.

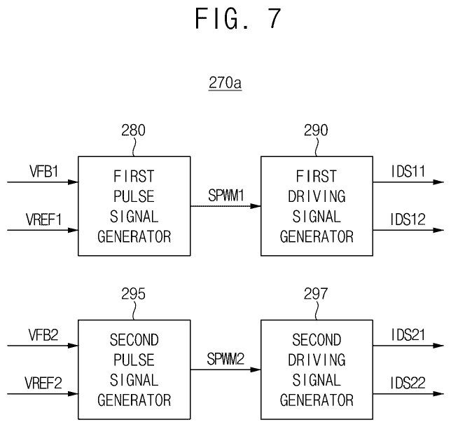

FIG. 7 is a block diagram illustrating an example of the control circuit in the multi-output voltage converter of FIG. 1 according to example embodiments.

Referring to FIG. 7, the control circuit 270a may include a first pulse signal generator, a first driving signal generator 290, a second pulse signal generator 295 and a second driving signal generator 297.

The first pulse signal generator 280 may generate a first pulse-width modulation (PWM) signal SPWM1 based on the first feedback voltage VFB1 and the first reference voltage VREF1 and may provide the first PWM signal SPWM1 to the first driving signal generator 290. The first driving signal generator 290 may generate the first internal driving signal IDS11 and the third internal driving signal IDS12 based on the first PWM signal SPWM1.

The second pulse signal generator 295 may generate a second PWM signal SPWM2 based on the second feedback voltage VFB2 and the second reference voltage VREF2 and may provide the second PWM signal SPWM2 to the second driving signal generator 297. The second driving signal generator 297 may generate the second internal driving signal IDS21 and the fourth internal driving signal IDS22 based on the second PWM signal SPWM2.

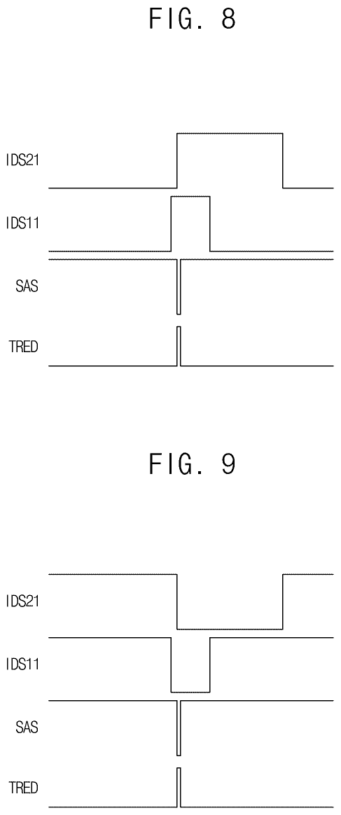

FIG. 8 is a timing diagram illustrating an operation of the SAS generator of FIG. 5A according to example embodiments.

Referring to FIG. 8, the strength adjusting signal SAS may transition to and maintain a logic low level during a time period in response to detecting that an activation transition of the first internal driving signal IDS11 and an activation transition of the second internal driving signal IDS21 occur simultaneously.

In FIG. 8, a signal TRED indicates that the activation transition of the first internal driving signal IDS11 and the activation transition of the second internal driving signal IDS21 occur simultaneously in the multi-output voltage converter 10a of FIG. 1.

FIG. 9 is a timing diagram illustrating an operation of the SAS generator of FIG. 5A according to example embodiments.

Referring to FIG. 9, the strength adjusting signal SAS maintains a logic low level during a time period in which a deactivation period of the first internal driving signal IDS11 and a deactivation period of the second internal driving signal IDS21 are overlapped.

In FIG. 9, a signal TRED indicates that the deactivation transition of the first internal driving signal IDS11 and the deactivation transition of the second internal driving signal IDS21 occur simultaneously in the multi-output voltage converter 10a of FIG. 1.

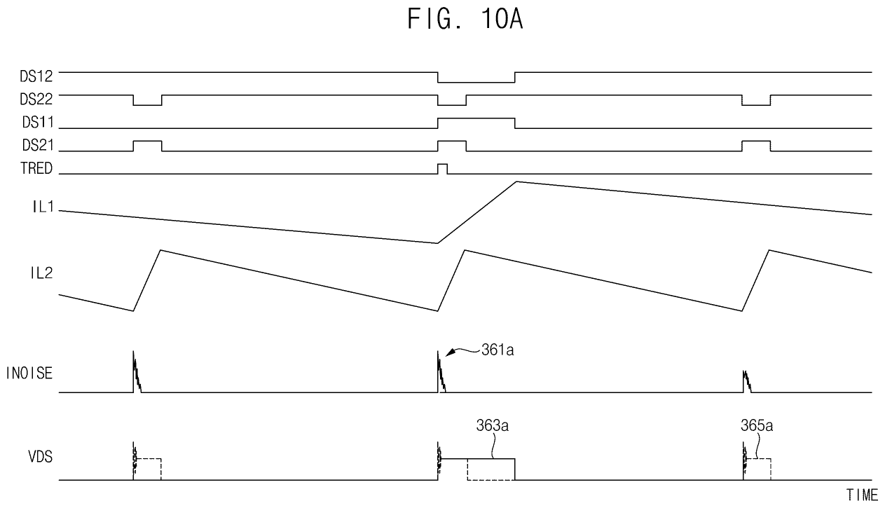

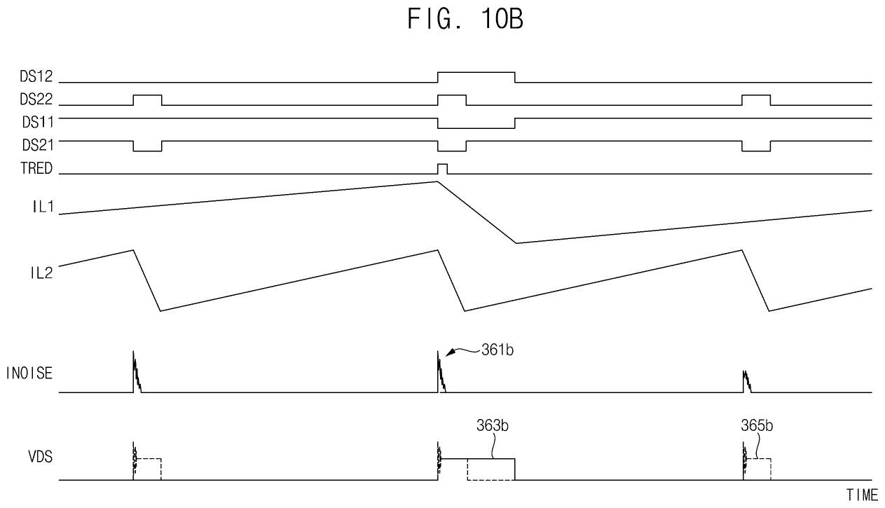

FIG. 10A is a timing diagram illustrating an example operation of the multi-output voltage converter 10a of FIG. 1 according to example embodiments.

In FIG. 10A, waveforms of the first driving signal DS11, the second driving signal DS21, the third driving signal DS12, the fourth driving signal DS22, the first inductor current IL1, the second inductor current IL2, a noise current INOISE, the signal TRED and a drain-source voltage VDS of each of the third power transistor 213 and the fourth power transistor 223 are illustrated.

The signal TRED is a signal for indicating that the activation transition of the first internal driving signal IDS11 and the activation transition of the second internal driving signal IDS21 occur simultaneously.

Each of the first inductor current IL1 and the second inductor current IL2 may increase or decrease, respectively, depending on whether respective one of the first driving signal DS11, the second driving signal DS21, the third driving signal DS12 and the fourth driving signal DS22 are activated or deactivated.

At time points at which the first driving signal DS11 or the second driving signal DS21 is activated, the noise current INOISE generated by parasitic inductances and parasitic capacitances may reach peak values.

As a reference numeral 361a indicates, according to embodiments, a peak value of the noise current INOISE of a case in which a first activation time point of the first driving signal DS11 is simultaneous with a second activation time point of the second driving signal DS21 may be controlled to be substantially similar with a peak value of the noise current INOISE of a case in which the first activation time point of the first driving signal DS11 is not simultaneous with the second activation time point of the second driving signal DS21. When the first activation time point of the first driving signal DS11 is simultaneous with the second activation time point of the second driving signal DS21, the first driving circuit 100a reduces the driving strength of the first driving signal DS11 based on the strength adjusting signal SAS and the second driving circuit 150a reduces the driving strength of the second driving signal DS21 based on the strength adjusting signal SAS. Therefore, the peak value of the noise current INOISE of a case in which the first activation time point of the first driving signal DS11 is simultaneous with the second activation time point of the second driving signal DS21 may be controlled to be similar with the peak value of the noise current INOISE of a case in which the first activation time point of the first driving signal DS11 is not simultaneous with the second activation time point of the second driving signal DS21.

In FIG. 10A, a reference numeral 363a indicates a drain-source voltage of the third power transistor 213 and a reference numeral 365a indicates a drain-source voltage of the fourth power transistor 223.

FIG. 10B is a timing diagram illustrating an example operation of the multi-output voltage converter 10a of FIG. 1 according to example embodiments.

In FIG. 10B, waveforms of the first driving signal DS11, the second driving signal DS21, the third driving signal DS12, the fourth driving signal DS22, the first inductor current IL1, the second inductor current IL2, a noise current INOISE, the signal TRED and a drain-source voltage VDS of each of the third power transistor 213 and the fourth power transistor 223 are illustrated.

The signal TRED is a signal for indicating that the deactivation interval of the first internal driving signal IDS11 and the deactivation interval of the second internal driving signal IDS21 occur simultaneously.

Each of the first inductor current IL1 and the second inductor current IL2 may decrease or increase, respectively, depending on whether respective ones of the first driving signal DS11, the second driving signal DS21, the third driving signal DS12 and the fourth driving signal DS22 are deactivated or activated.

At time points at which the first driving signal DS11 or the second driving signal DS21 is deactivated, the noise current INOISE generated by parasitic inductances and parasitic capacitances may reach peak values.

As a reference numeral 361b indicates, a peak value of the noise current INOISE of a case in which a first deactivation time point of the first driving signal DS11 is simultaneous with a second deactivation time point of the second driving signal DS21 may be controlled to be substantially similar with a peak value of the noise current INOISE of a case in which the first deactivation time point of the first driving signal DS11 is not simultaneous with the second deactivation time point of the second driving signal DS21. When the first deactivation time point of the first driving signal DS11 is simultaneous with the second deactivation time point of the second driving signal DS21, the first driving circuit 100a reduces the driving strength of the first power transistor 211 which is driven by the first driving signal DS11 based on the strength adjusting signal SAS and the second driving circuit 150a reduces the driving strength of the second power transistor 221 which is driven by the second driving signal DS21 based on the strength adjusting signal SAS. Therefore, the peak value of the noise current INOISE of a case in which the first deactivation time point of the first driving signal DS11 is simultaneous with the second deactivation time point of the second driving signal DS21 may be controlled to be similar with the peak value of the noise current INOISE of a case in which the first deactivation time point of the first driving signal DS11 is not simultaneous with the second deactivation time point of the second driving signal DS21.

In FIG. 10B, a reference numeral 363b indicates a drain-source voltage of the third power transistor 213 and a reference numeral 365b indicates a drain-source voltage of the fourth power transistor 223.

As mentioned with reference to FIGS. 10A and 10B, when a first transition timing of the first driving signal DS11 is simultaneous with a second transition timing of the second driving signal DS21, the first driving circuit 100a reduces the driving strength of the first power transistor 211 driven by the first driving signal DS11 based on the strength adjusting signal SAS and the second driving circuit 150a reduces the driving strength of the second power transistor 221 driven by the second driving signal DS21 based on the strength adjusting signal SAS. Therefore, the peak value of the noise current INOISE of a case in which the first transition timing of the first driving signal DS11 is simultaneous with the second transition timing of the second driving signal DS21 may be controlled to be similar with the peak value of the noise current INOISE of a case in which the first transition timing of the first driving signal DS11 is not simultaneous with the second transition timing of the second driving signal DS21.

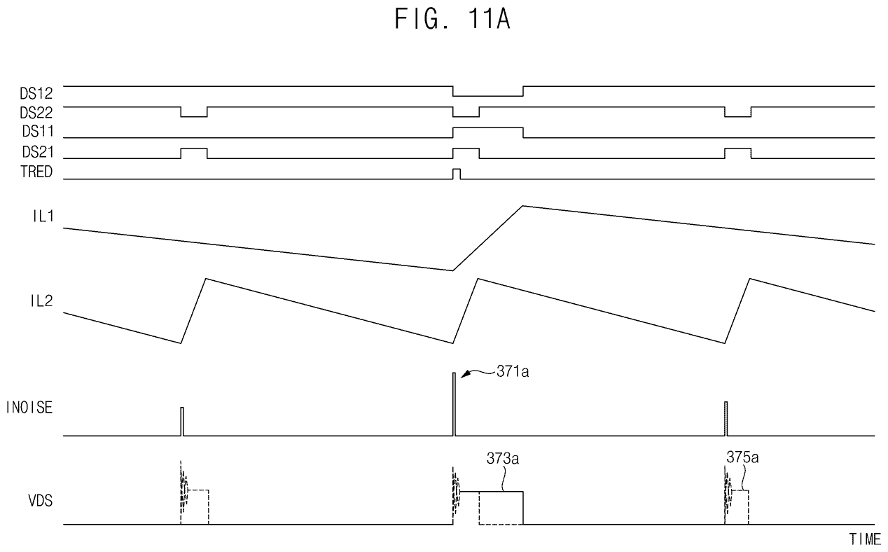

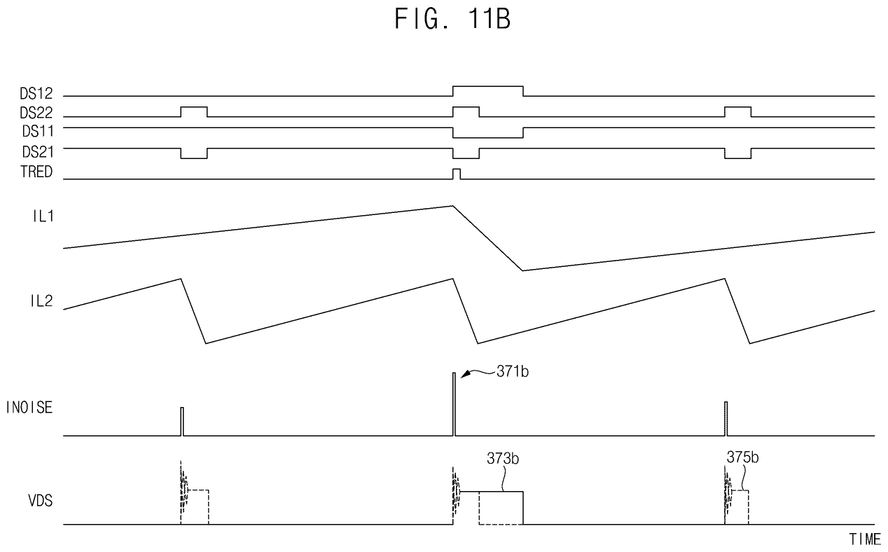

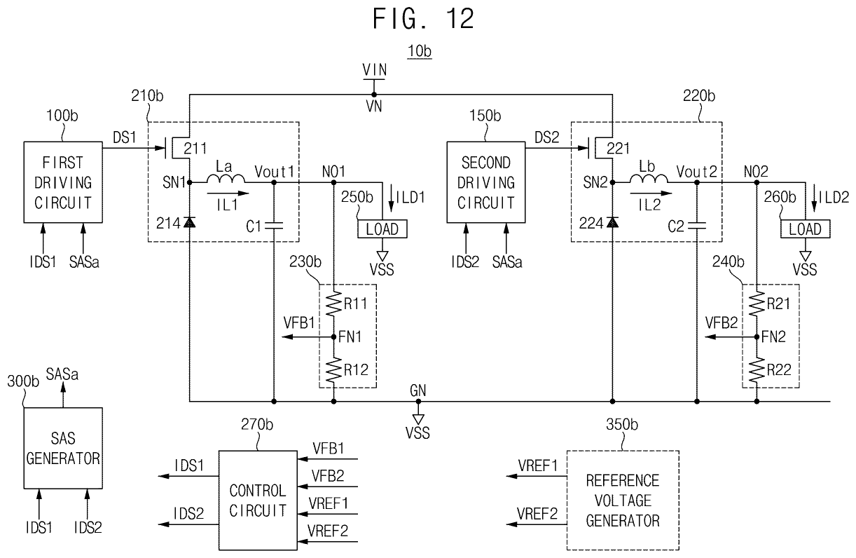

FIG. 11A is a timing diagram illustrating an example operation of the multi-output voltage converter 10a of FIG. 1 when the multi-output voltage converter 10a does not generate the strength adjusting signal SAS.

In FIG. 11A, waveforms of the first driving signal DS11, the second driving signal DS21, the third driving signal DS12, the fourth driving signal DS22, the first inductor current IL1, the second inductor current IL2, a noise current INOISE, the signal TRED and a drain-source voltage VDS of each of the third power transistor 213 and the fourth power transistor 223 are illustrated.

Each of the first inductor current IL1 and the second inductor current IL2 may increase or decrease, respectively, depending on whether respective ones of the first driving signal DS11, the second driving signal DS21, the third driving signal DS12 and the fourth driving signal DS22 are activated and deactivated.

At time points at which the first driving signal DS11 or the second driving signal DS21 is activated, the noise current INOISE generated by parasitic inductances and parasitic capacitances has peak values.

As a reference numeral 371a indicates, a peak value of the noise current INOISE of a case in which a first activation time point of the first driving signal DS11 is simultaneous with a second activation time point of the second driving signal DS21 is greater than a peak value of the noise current INOISE of a case in which the first activation time point of the first driving signal DS11 is not simultaneous with the second activation time point of the second driving signal DS21. It is noted that a significant level of noise may be generated when the first activation time point of the first driving signal DS11 is simultaneous with the second activation time point of the second driving signal DS21.

In FIG. 11A, a reference numeral 373a indicates a drain-source voltage of the third power transistor 213 and a reference numeral 375a indicates a drain-source voltage of the fourth power transistor 223.

FIG. 11B is a timing diagram illustrating an example operation of the multi-output voltage converter 10a of FIG. 1 when the multi-output voltage converter 10a does not generate the strength adjusting signal SAS.

Each of the first inductor current IL1 and the second inductor current IL2 may decrease and increase, respectively, depending on whether respective ones of the first driving signal DS11, the second driving signal DS21, the third driving signal DS12 and the fourth driving signal DS22 are deactivated or activated.

At time points at which the first driving signal DS11 or the second driving signal DS21 is deactivated, the noise current INOISE generated by parasitic inductances and parasitic capacitances has peak values.

As a reference numeral 371b indicates, a peak value of the noise current INOISE of a case in which a first deactivation time point of the first driving signal DS11 is simultaneous with a second deactivation time point of the second driving signal DS21 is greater than a peak value of the noise current INOISE of a case in which the first deactivation time point of the first driving signal DS11 is not simultaneous with the second deactivation time point of the second driving signal DS21. It is noted that a significant level of noise is generated when the first deactivation time point of the first driving signal DS11 is simultaneous with the second deactivation time point of the second driving signal DS21.

In FIG. 11B, a reference numeral 373b indicates a drain-source voltage of the third power transistor 213 and a reference numeral 375b indicates a drain-source voltage of the fourth power transistor 223.

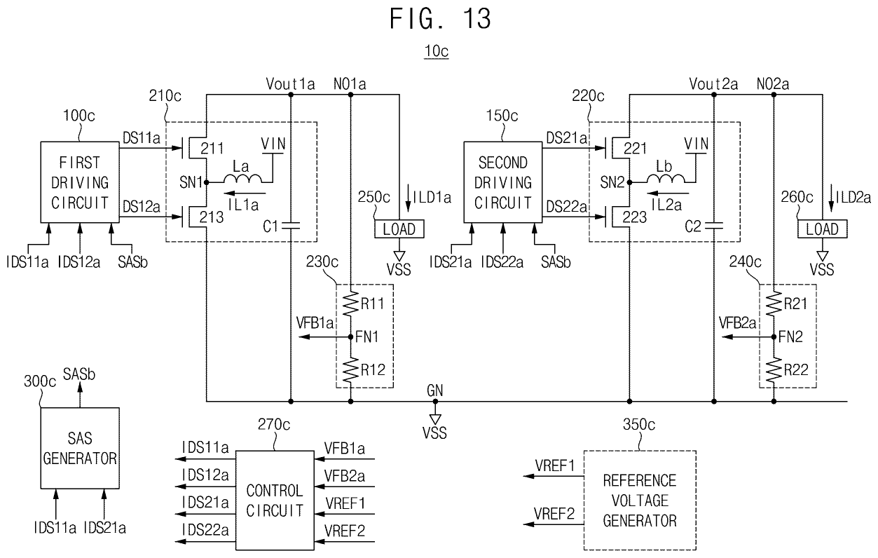

FIG. 12 is a block diagram illustrating an example of a multi-output voltage converter according to example embodiments.

In FIG. 12, descriptions repeated with FIG. 1 will be omitted for convenience of explanation.

Referring to FIG. 12, a multi-output voltage converter 10b may include a first driving circuit 100b, a second driving circuit 150b, a first converting circuit 210b, a second converting circuit 220b, a first feedback circuit 230b, a second feedback circuit 240b, a control circuit 270b and an SAS generator 300b. The multi-output voltage converter 10b may further include a reference voltage generator 350b.

In FIG. 12, a load 250b coupled to a first output node NO1 of the multi-output voltage converter 10b and a load 260b coupled to a second output node NO2 of the multi-output voltage converter 10b are also shown for convenience of explanation.

The first converting circuit 210b may be connected between the voltage node VN and the ground node GN and may include a first power transistor 211, a diode 214, a first inductor La and a first capacitor C1. The voltage node VN may be connected to the input voltage VN and the ground node GN may be connected to the ground voltage VSS. The first converting circuit 210b may generate a first output voltage Vout1 at a first voltage level at the first output node NO1 by converting the voltage level of the input voltage VIN to the first voltage level based on a first driving signal DS1.

The first power transistor 211 may be coupled between the input voltage VIN and a first switching node SN1, and may have a gate receiving the first driving signal DS1. The first power transistor 211 may be implemented with an NMOS transistor. The diode 214 may be coupled between the first switching node SN1 and the ground voltage VSS. The first inductor La may be coupled between the first switching node SN1 and the first output node NO1 and the first capacitor C1 may be coupled between the first output node NO1 and the ground voltage VSS.

The first power transistor 211 may be turned-on and pull-up the first switching node SN1 in response to the first driving signal DS1 being activated with a logic high level.

The first feedback circuit 230b may generate a first feedback voltage VFB1 proportional to the first output voltage Vout1 and may provide the first feedback voltage VFB1 to the control circuit 270b.

The second converting circuit 220b may be connected between the voltage node VN and the ground node GN and may include a second power transistor 221, a diode 224, a second inductor Lb and a second capacitor C2. The second converting circuit 220b may generate a second output voltage Vout2 at a second output node NO2 by converting the input voltage VIN based on a second driving signal DS2.

The second power transistor 221 may be coupled between the input voltage VIN and a second switching node SN2, and may have a gate receiving the second driving signal DS2. The second power transistor 221 may be implemented with an NMOS transistor. The diode 224 may be coupled between the second switching node SN2 and the ground voltage VSS. The second inductor Lb may be coupled between the second switching node SN2 and the second output node NO2 and the second capacitor C2 may be coupled between the second output node NO2 and the ground voltage VSS.

The second power transistor 221 may be turned-on and pull-up the second switching node SN2 in response to the second driving signal DS21 being activated with a logic high level.

The second feedback circuit 240b may generate a second feedback voltage VFB2 proportional to the second output voltage Vout2 and may provide the second feedback voltage VFB2 to the control circuit 270b.

The reference voltage generator 350b may generate a first reference voltage VREF1 and a second reference voltage VREF2 and may provide the first reference voltage VREF1 and the second reference voltage VREF2 to the control circuit 270b.

The control circuit 270b may receive the first feedback voltage VFB1, the second feedback voltage VFB2, the first reference voltage VREF1 and the second reference voltage VREF2, may generate a first internal driving signal IDS1 by comparing the first feedback voltage VFB1 with the first reference voltage VREF1 and may generate a second internal driving signal IDS2 by comparing the second feedback voltage VFB2 with the second reference voltage VREF2. The first driving circuit 100b may generate the first driving signal DS1 based on the first internal driving signal IDS1. The second driving circuit 150b may generate the second driving signal DS2 based on the second internal driving signal IDS2.

The control circuit 270b may provide the first internal driving signal IDS1 to the first driving circuit 100b, may provide the second internal driving signal IDS2 to the second driving circuit 150b and may provide the first internal driving signal IDS1 and the second internal driving signal IDS2 to the SAS generator 300b.

The SAS generator 300b may receive the first internal driving signal IDS1 and the second internal driving signal IDS2, may monitor a first transition timing of the first internal driving signal IDS1 and a second transition timing of the second internal driving signal IDS2, may generate a strength adjusting signal SASa transitioning to a first logic level based on the first transition timing of the first internal driving signal IDS1 and the second transition timing of the second internal driving signal IDS2 and may provide the strength adjusting signal SASa to the first driving circuit 100b and the second driving circuit 150b. The strength adjusting signal SAS may transition to a logic low level when the first internal driving signal IDS1 and the second internal driving signal IDS2 transition to the same logic level simultaneously. The SAS generator 300b may generate the strength adjusting signal SASa having a logic low level upon detecting that the first transition timing of the first internal driving signal IDS1 is substantially simultaneous with the second transition timing of the second internal driving signal IDS2.

The first driving circuit 100b may generate the first driving signal DS1 based on the first internal driving signal IDS1, and may dynamically reduce a driving strength of the first power transistor 211 driven by the first driving signal DS1 based on the strength adjusting signal SASa and the first internal driving signal IDS1.

The second driving circuit 150b may generate the second driving signal DS2 based on the second internal driving signal IDS2, and may selectively reduce a driving strength of the second power transistor 221 driven by the second driving signal DS2 based on the strength adjusting signal SASa and the second internal driving signal IDS2.

Based on the strength adjusting signal SASa indicating that the first transition timing of the first internal driving signal IDS1 is simultaneous with the second transition timing of the second internal driving signal IDS2, the first driving circuit 100 may reduce the driving strength of the first power transistor 211 driven by the first driving signal DS1 based on the strength adjusting signal SASa and the first internal driving signal IDS1, and the second driving circuit 150b may reduce the driving strength of the second power transistor 221 driven by the second driving signal DS2 based on the strength adjusting signal SASa and the second internal driving signal IDS2.

Therefore, when the first transition timing of the first internal driving signal IDS1 is simultaneous with the second transition timing of the second internal driving signal IDS2 and the first power transistor 211 and the second power transistor 221 are simultaneously turned-on or simultaneously turned-off, each driving strength of the first driving signal DS1 and the second driving signal DS2 is reduced. Accordingly, a ground noise generated at the ground node GN of the multi-output voltage converter 10b may be reduced, leading to overall reduction in switching loss of the multi-output voltage converter.

FIG. 13 is a block diagram illustrating an example of a multi-output voltage converter according to example embodiments.

In FIG. 13, descriptions repeated with FIG. 1 will be omitted for convenience of explanation.

Referring to FIG. 13, a multi-output voltage converter 10c may include a first driving circuit 100c, a second driving circuit 150c, a first converting circuit 210c, a second converting circuit 220c, a first feedback circuit 230c, a second feedback circuit 240c, a control circuit 270c and an SAS generator 300c. The multi-output voltage converter 10c may further include a reference voltage generator 350c.

In FIG. 13, a load 250c coupled to a first output node NO1a of the multi-output voltage converter 10c and a load 260b coupled to a second output node NO2a of the multi-output voltage converter 10c are also shown for convenience of explanation.

The first converting circuit 210c may be connected between the first output node NO1a and a ground node GN and may include a first power transistor 211, a third power transistor 213, a first inductor La coupled to the input voltage VIN and a first capacitor C1. The ground node GN may be connected to a ground voltage VSS. The first converting circuit 210b may generate a first output voltage Vout1a at the first output node NO1a by converting the input voltage VIN based on a first driving signal DS11a and a third driving signal DS12a. A voltage level of the first output voltage Vout1a may be smaller than a voltage level of the input voltage VIN.

The first power transistor 211 may be coupled between the first output node NO1a and a first switching node SN1, and may have a gate receiving the first driving signal DS11a. The first power transistor 211 may be implemented with an NMOS transistor. The third power transistor 213 may be coupled between the first switching node SN1 and the ground voltage VSS, and may have a gate receiving the third driving signal DS12a. The power transistor 213 may be implemented with an NMOS transistor. The first inductor La may be coupled between the input voltage VIN and the first switching node SN1 and the first capacitor C1 may be coupled between the first output node NO1a and the ground voltage VSS.

The first power transistor 211 may be turned-on and may provide an energy stored in the first inductor La as a first out voltage Vout1a at the first output node NO1a in response to the first driving signal DS11a being activated with a logic high level. The power transistor 213 may be turned-on and pull-down the first switching node SN1 in response to the third driving signal DS12a being activated with a logic high level.

The first inductor La may store energy based on the input voltage VIN. A first indictor current IL1a may flow to the first switching node SN1 from the first inductor La. The first capacitor C1 may store the first output voltage Vout1a.

The first feedback circuit 230c may generate a first feedback voltage VFB1a proportional to the first output voltage Vout1a and may provide the first feedback voltage VFB1a to the control circuit 270c.

The second converting circuit 220c may be connected between a second output node NO2a and the ground node GN and may include a second power transistor 221, a fourth power transistor 223, a second inductor Lb coupled to the input voltage VIN and a second capacitor C2. The second converting circuit 220c may generate a second output voltage Vout2a at a second output node NO2a by converting the input voltage VIN based on a second driving signal DS2a1 and a fourth driving signal DS22a.

The second power transistor 221 may be coupled between the second output node NO2a and a second switching node SN2, and may have a gate receiving the second driving signal DS21a. The second power transistor 221 may be implemented with an NMOS transistor. The fourth power transistor 223 may be coupled between the second switching node SN2 and the ground voltage VSS, and may have a gate receiving the fourth driving signal DS22a. The fourth power transistor 223 may be implemented with an NMOS transistor. The first inductor La may be coupled between the input voltage VIN and the second switching node SN2 and the second capacitor C2 may be coupled between the second output node NO2a and the ground voltage VSS.

The second power transistor 221 may be turned-on and may provide an energy stored in the second inductor Lb as the second out voltage Vout2a at the second output node NO2a in response to the second driving signal DS21a being activated with a logic high level. The fourth power transistor 223 may be turned-on and pull-down the second switching node SN2 in response to the fourth driving signal DS22a being activated with a logic high level.

The second inductor Lb may store energy based on the input voltage VIN. A second indictor current IL2a may flow to the second switching node SN2 from the second inductor Lb. The second capacitor C2 may store the second output voltage Vout2a.

The second feedback circuit 240c may generate a second feedback voltage VFB2a proportional to the second output voltage Vout2a and may provide the second feedback voltage VFB2a to the control circuit 270c.

A first load current ILD1a may flow into the load 250c based on the first output voltage Vout1a and a second load current ILD2a may flow into the load 260c based on the second output voltage Vout2a.

The first driving circuit 100c, the first converting circuit 210c and the first feedback circuit 230c may constitute a first boost converter and the second driving circuit 150c, the second converting circuit 220c and the second feedback circuit 240c may constitute a second boost converter.

The reference voltage generator 350c may generate a first reference voltage VREF1 and a second reference voltage VREF2 and may provide the first reference voltage VREF1 and the second reference voltage VREF2 to the control circuit 270c.

The control circuit 270c may receive the first feedback voltage VFB1a, the second feedback voltage VFB2a, the first reference voltage VREF1 and the second reference voltage VREF2, may generate a first internal driving signal IDS11a and a third internal driving signal IDS12a based on comparing the first feedback voltage VFB1a with the first reference voltage VREF1 and may generate a second internal driving signal IDS21a and a fourth internal driving signal IDS22a based on comparing the second feedback voltage VFB2a with the second reference voltage VREF2. The first internal driving signal IDS11a may be associated with the first driving signal DS11a, the third internal driving signal IDS12a may be associated with the third driving signal DS12a, the second internal driving signal IDS21a may be associated with the second driving signal DS21a and the fourth internal driving signal IDS22a may be associated with the fourth driving signal DS22a.

The control circuit 270c may provide the first internal driving signal IDS11a and the third internal driving signal IDS12a to the first driving circuit 100c, may provide the second internal driving signal IDS21a and the fourth internal driving signal IDS22a to the second driving circuit 150c and may provide the first internal driving signal IDS11a and the second internal driving signal IDS21a to the SAS generator 300c.

The SAS generator 300c may receive the first internal driving signal IDS11a and the second internal driving signal IDS21a, may monitor a first transition timing of the first internal driving signal IDS11a and a second transition timing of the second internal driving signal IDS21a, may generate a strength adjusting signal SASb transitioning to a first logic level in response to detecting that the first transition timing of the first internal driving signal IDS11a is simultaneous with the second transition timing of the second internal driving signal IDS21a and may provide the strength adjusting signal SASb to the first driving circuit 100c and the second driving circuit 150c. The SAS generator 300c may generate the strength adjusting signal SASb at a logic level depending on whether the first transition timing of the first internal driving signal IDS11a is simultaneous with the second transition timing of the second internal driving signal IDS21a.

The implementation of the SAS generator 300c may be the same as that of the SAS generator 300a of FIG. 5A or the SAS generator 300a_1 of FIG. 5B.

The first driving circuit 100c may generate the first driving signal DS11a based on the first internal driving signal IDS11a, may generate the third driving signal DS12a based on the third internal driving signal IDS12a, and may dynamically reduce a driving strength of the first power transistor 211 driven by the first driving signal DS11a based on the strength adjusting signal SASb and the first internal driving signal IDS11a.

Based on the strength adjusting signal SASb indicating that the first transition timing of the first internal driving signal IDS11a is simultaneous with the second transition timing of the second internal driving signal IDS21a, the first driving circuit 100c may reduce the driving strength of the first power transistor 211 driven by the first driving signal DS11a based on the strength adjusting signal SASb and the first internal driving signal IDS11a. Based on the strength adjusting signal SASb indicating that the first transition timing of the first internal driving signal IDS11a is not simultaneous with the second transition timing of the second internal driving signal IDS21a, the first driving circuit 100c may maintain normal driving strength of the first power transistor 211 driven by the first driving signal DS11a based on the strength adjusting signal SASb and the first internal driving signal IDS11a.

The second driving circuit 150c may generate the second driving signal DS21a based on the second internal driving signal IDS21a, may generate the fourth driving signal DS22a based on the fourth internal driving signal IDS22a, and may selectively reduce a driving strength of the second power transistor 221 driven by the second driving signal DS21a based on the strength adjusting signal SASb and the second internal driving signal IDS21a.

Based on the strength adjusting signal SASb indicating that the first transition timing of the first internal driving signal IDS11a is simultaneous with the second transition timing of the second internal driving signal IDS21a, the second driving circuit 150c may reduce the driving strength of the second power transistor 221 driven by the second driving signal DS21a based on the strength adjusting signal SASb and the second internal driving signal IDS21a. Based on the strength adjusting signal SASb indicating that the first transition timing of the first internal driving signal IDS11a is not simultaneous with the second transition timing of the second internal driving signal IDS21a, the second driving circuit 150c may maintain the driving strength of the second power transistor 221 driven by the second driving signal DS21a based on the strength adjusting signal SASb and the second internal driving signal IDS21a.

Therefore, when the first transition timing of the first internal driving signal IDS11a is simultaneous with the second transition timing of the second internal driving signal IDS21a and the first power transistor 211 and the second power transistor 221 are simultaneously turned-on or simultaneously turned-off, each driving strength of the first power transistor 211 and the second power transistor 221 driven by each of the first driving signal DS11a and the second driving signal DS21a is reduced. Accordingly, a ground noise generated at the ground node GN of the multi-output voltage converter 10c may be reduced, leading to overall reduction of switching loss of the multi-output voltage converter.

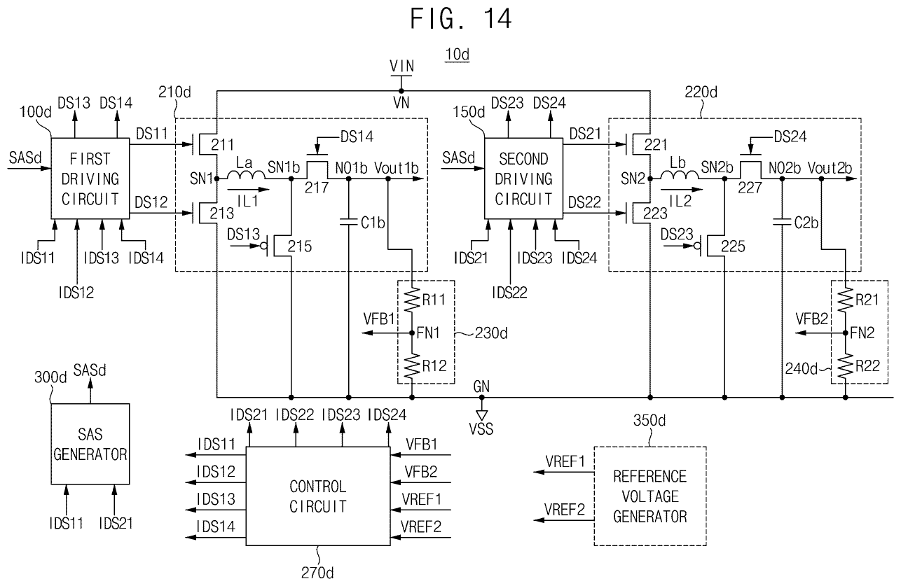

FIG. 14 is a block diagram illustrating an example of a multi-output voltage converter according to example embodiments.

In FIG. 14, descriptions repeated with FIG. 1 will be omitted for convenience of explanation.

Referring to FIG. 14, a multi-output voltage converter 10d may include a first driving circuit 100d, a second driving circuit 150d, a first converting circuit 210d, a second converting circuit 220d, a first feedback circuit 230d, a second feedback circuit 240d, a control circuit 270d and an SAS generator 300d. The multi-output voltage converter 10d may further include a reference voltage generator 350d.

The first converting circuit 210d may be connected between a voltage node VN and a ground node GN and may include a first power transistor 211, a third power transistor 213, a fifth power transistor 215, a seventh power transistor 217, a first inductor La and a first capacitor C1b. The voltage node VN may be connected to an input voltage VN and the ground node GN may be connected to a ground voltage VSS. The first converting circuit 210d may generate a first output voltage Vout1b at a first output node NO1b by converting the input voltage VIN based on a first set of driving signals DS11, DS12, DS13 and DS14. A voltage level of the first output voltage Vout1b may be smaller than or greater than a voltage level of the input voltage VIN.

The first power transistor 211 may be coupled between the input voltage VIN and a first switching node SN1, and may have a gate receiving the first driving signal DS11. The first power transistor 211 may be implemented with an NMOS transistor. The third power transistor 213 may be coupled between the first switching node SN1 and the ground voltage VSS, and may have a gate receiving the driving signal DS12. The power transistor 213 may be implemented with an NMOS transistor.

The fifth power transistor 215 may be coupled between a third switching node SN1b and the ground voltage VSS, and may have a gate receiving the driving signal DS13. The fifth power transistor 215 may be implemented with an NMOS transistor. The seventh power transistor 217 may be coupled between the third switching node SN1b and the first output node NO1b, and may have a gate receiving the driving signal DS14. The seventh power transistor 217 may be implemented with an NMOS transistor.

The first inductor La may be coupled between the first switching node SN1 and the third switching node SN1b, and the first capacitor C1b may be coupled between the first output node NO1b and the ground voltage VSS. A first inductor current IL1 may flow to the third switching node SN1b from the first inductor La.

The first power transistor 211 may be turned-on and pull-up the first switching node SN1 in response to the first driving signal DS11 being activated with a logic high level. The third power transistor 213 may be turned-on and pull-down the first switching node SN1 in response to the driving signal DS12 being activated with a logic high level.

The fifth power transistor 215 may be turned-on and pull-down the third switching node SN1b in response to the driving signal DS13 being activated with a logic high level. The seventh power transistor 217 may be turned-on and may provide the first output node NO1b with a voltage of the third switching node SN1b as the first output voltage Vout1b, in response to the driving signal DS14 being activated with a logic high level.

The first feedback circuit 230d may generate a first feedback voltage VFB1 proportional to the first output voltage Vout1b and may provide the first feedback voltage VFB1 to the control circuit 270d.

The second converting circuit 220d may be connected between the voltage node VN and the ground node GN and may include a second power transistor 221, a fourth power transistor 223, a sixth power transistor 225, an eighth power transistor 227, a second inductor Lb and a second capacitor C2b. The second converting circuit 220d may generate a second output voltage Vout2b at a second output node NO2b by converting the input voltage VIN based on a second set of driving signals DS21, DS22, DS23 and DS24. A voltage level of the second output voltage Vout2b may be smaller than or greater than a voltage level of the input voltage VIN.

The second power transistor 221 may be coupled between the input voltage VIN and a second switching node SN2, and may have a gate receiving the second driving signal DS21. The second power transistor 221 may be implemented with an NMOS transistor. The fourth power transistor 223 may be coupled between the second switching node SN2 and the ground voltage VSS, and may have a gate receiving the driving signal DS22. The fourth power transistor 223 may be implemented with an NMOS transistor.

The sixth power transistor 225 may be coupled between a fourth switching node SN2b and the ground voltage VSS, and may have a gate receiving the driving signal DS23. The sixth power transistor 225 may be implemented with an NMOS transistor. The eighth power transistor 227 may be coupled between the fourth switching node SN2b and the second output node NO2b, and may have a gate receiving the driving signal DS24. The power transistor 227 may be implemented with an NMOS transistor.

The second inductor Lb may be coupled between the second switching node SN2 and the fourth switching node SN2b, and the second capacitor C2b may be coupled between the second output node NO2 and the ground voltage VSS. A second inductor current IL2 may flow to the fourth switching node SN2b from the second inductor Lb.

The second power transistor 221 may be turned-on and pull-up the second switching node SN2 in response to the second driving signal DS21 being activated with a logic high level. The fourth power transistor 223 may be turned-on and pull-down the second switching node SN2 in response to the driving signal DS22 being activated with a logic high level.

The sixth power transistor 225 may be turned-on and pull-down the fourth switching node SN2b in response to the driving signal DS23 being activated with a logic high level. The eighth power transistor 227 may be turned-on and may provide the second output node NO2b with a voltage of the fourth switching node SN2b as the second output voltage Vout2b, in response to the driving signal DS24 being activated with a logic high level.

The second feedback circuit 240d may generate a second feedback voltage VFB2 proportional to the second output voltage Vout2b and may provide the second feedback voltage VFB2 to the control circuit 270d.

The first driving circuit 100d, the first converting circuit 210d and the first feedback circuit 230d may constitute a first buck-boost converter and the second driving circuit 150d, the second converting circuit 220d and the second feedback circuit 240d may constitute a second buck-boost converter.

The reference voltage generator 350d may generate a first reference voltage VREF1 and a second reference voltage VREF2 and may provide the first reference voltage VREF1 and the second reference voltage VREF2 to the control circuit 270d.

The control circuit 270d may receive the first feedback voltage VFB1, the second feedback voltage VFB2, the first reference voltage VREF1 and the second reference voltage VREF2, may generate a first set of internal driving signals IDS11, IDS12, IDS13 and IDS14 based on comparing the first feedback voltage VFB1 with the first reference voltage VREF1 and may generate a second set of internal driving signals IDS21, IDS22, IDS23 and IDS24 based on comparing the second feedback voltage VFB2 with the second reference voltage VREF2. Each of the first set of internal driving signals IDS11, IDS12, IDS13 and IDS14 may be associated with respective one of the first set of driving signals DS11, DS12, DS13 and DS14 and each of the second set of internal driving signals IDS21, IDS22, IDS23 and IDS24 may be associated with respective one of the second set of driving signals DS21, DS22, DS23 and DS24.

The control circuit 270d may provide the first set of internal driving signals IDS11, IDS12, IDS13 and IDS14 to the first driving circuit 100d, may provide the second set of internal driving signals IDS21, IDS22, IDS23 and IDS24 to the second driving circuit 150d and may provide the first internal driving signal IDS11 and the second internal driving signal IDS21 to the SAS generator 300d.

The SAS generator 300d may receive the first internal driving signal IDS11 and the second internal driving signal IDS21, may detect a first transition timing of the first internal driving signal IDS11 and a second transition timing of the second internal driving signal IDS21, may generate a strength adjusting signal SASd transitioning to a first logic level in response to detecting the first transition timing of the first internal driving signal IDS11 being simultaneous with the second transition timing of the second internal driving signal IDS21 and may provide the strength adjusting signal SASd to the first driving circuit 100d and the second driving circuit 150d. The SAS generator 300d may generate the strength adjusting signal SASd having a logic low level depending on whether the first transition timing of the first internal driving signal IDS11 is simultaneous with the second transition timing of the second internal driving signal IDS21.

The SAS generator 300d may employ the SAS generator 300a of FIG. 5A or the SAS generator 300a_1 of FIG. 5B.

The first driving circuit 100d may generate each of the first set of driving signals DS11, DS12, DS13 and DS14 based on respective one of the first set of internal driving signals IDS11, IDS12, IDS13 and IDS14 and may selectively reduce a driving strength of the first power transistor 211 driven by the first driving signal DS11 based on the strength adjusting signal SASd and the first internal driving signal IDS11.

Based on the strength adjusting signal SASd indicating that the first transition timing of the first internal driving signal IDS11 is simultaneous with the second transition timing of the second internal driving signal IDS21, the first driving circuit 100d may reduce the driving strength of the first power transistor 211 driven by the first driving signal DS11 based on the strength adjusting signal SASd and the first internal driving signal IDS11. Based on the strength adjusting signal SASd indicating that the first transition timing of the first internal driving signal IDS11 is not simultaneous with the second transition timing of the second internal driving signal IDS21, the first driving circuit 100d may maintain normal driving strength of the first power transistor 211 based on the strength adjusting signal SASd and the first internal driving signal IDS11.

The second driving circuit 150d may generate each of the second set of driving signals DS21, DS22, DS23 and DS24 based on respective one of the second set of internal driving signals IDS21, IDS22, IDS23 and IDS24 and may selectively reduce a driving strength of the second power transistor 221 driven by the second driving signal DS21 based on the strength adjusting signal SASd and the second internal driving signal IDS21.

Based on the strength adjusting signal SASd indicating that the first transition timing of the first internal driving signal IDS11 is simultaneous with the second transition timing of the second internal driving signal IDS21, the second driving circuit 150d may reduce the driving strength of the second power transistor 221 driven by the second driving signal DS21 based on the strength adjusting signal SASd and the second internal driving signal IDS21. Based on the strength adjusting signal SASd indicating that the first transition timing of the first internal driving signal IDS11 is not simultaneous with the second transition timing of the second internal driving signal IDS21, the second driving circuit 150d may maintain the driving strength of the second power transistor 221 driven by the second driving signal DS21 based on the strength adjusting signal SASd and the second internal driving signal IDS21.

Therefore, when the first transition timing of the first internal driving signal IDS11 is simultaneous with the second transition timing of the second internal driving signal IDS21 and the first power transistor 211 and the second power transistor 221 are simultaneously turned-on or simultaneously turned-off, each driving strength of the first power transistor 211 and the second power transistor 221 driven by each of the first driving signal DS11 and the second driving signal DS21 is reduced. Accordingly, a ground noise generated at the ground node GN of the multi-output voltage converter 10d may be reduced, leading to overall reduction in switching loss of the multi-output voltage converter.

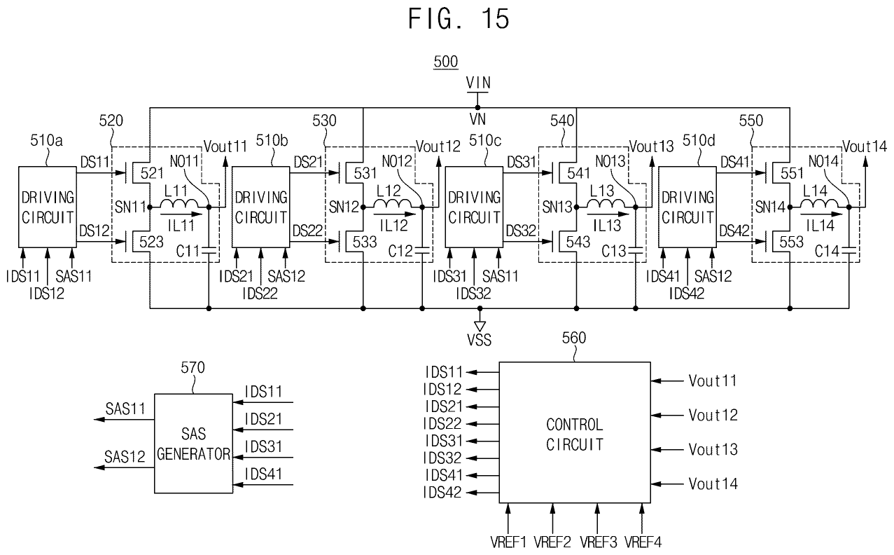

FIG. 15 is a block diagram illustrating an example of a multi-output voltage converter according to example embodiments.

Referring to FIG. 15, a multi-output voltage converter 500 may include a plurality of driving circuits 510a, 510b, 510c and 510d, a plurality of converting circuits 520, 530, 540, 550, a control circuit 560 and an SAS generator 570.

The converting circuit 520 may be connected between a voltage node VN and a ground voltage VSS and may include a first power transistor 521, a fifth power transistor 523, a first inductor L11 and a first capacitor C11. The voltage node VN may be connected to an input voltage VIN. The converting circuit 520 may generate a first output voltage Vout11 at a first output node NO11 by converting the input voltage VIN based on a driving signal DS11 and a driving signal DS12. A voltage level of the first output voltage Vout11 may be smaller than a voltage level of the input voltage VIN.

The first power transistor 521 may be coupled between the input voltage VIN and a first switching node SN11, and may have a gate receiving the driving signal DS11. The fifth power transistor 523 may be coupled between the first switching node SN11 and the ground voltage VSS, and may have a gate receiving the driving signal DS12. The first inductor L11 may be coupled between the first switching node SN11 and the first output node NO11, and the first capacitor C11 may be coupled between the first output node NO11 and the ground voltage VSS.

The first power transistor 521 may be turned-on and pull-up the first switching node SN11 in response to the driving signal DS11 being activated with a logic high level. The fifth power transistor 523 may be turned-on and pull-down the first switching node SN11 in response to the driving signal DS12 being activated with a logic high level.

The first inductor L11 and the first capacitor C11 may operate as a low pass filter and may output the first output voltage Vout11 at the first output node NO11 by filtering out high frequency components from the voltage at the first switching node SN11. A first indictor current IL11 may flow to the first output node NO11 from the first inductor IL11.

The converting circuit 530 may be connected between the voltage node VN and the ground node GN and may include a second power transistor 531, a sixth power transistor 533, a second inductor L12 and a second capacitor C12. The converting circuit 530 may generate a second output voltage Vout12 at a second output node NO12 by converting the input voltage VIN based on a driving signal DS21 and a driving signal DS22. A voltage level of the second output voltage Vout12 may be smaller than a voltage level of the input voltage VIN.

The second power transistor 531 may be coupled between the input voltage VIN and a second switching node SN12, and may have a gate receiving the driving signal DS21. The sixth power transistor 533 may be coupled between the second switching node SN12 and the ground voltage VSS, and may have a gate receiving the driving signal DS22. The second inductor L12 may be coupled between the second switching node SN12 and the second output node NO12, and the second capacitor C12 may be coupled between the second output node NO12 and the ground voltage VSS.

The second power transistor 531 may be turned-on and pull-up the second switching node SN12 in response to the driving signal DS21 being activated with a logic high level. The sixth power transistor 533 may be turned-on and pull-down the second switching node SN12 in response to the driving signal DS22 being activated with a logic high level.

The second inductor L12 and the second capacitor C12 may operate as a low pass filter and may output the second output voltage Vout12 at the second output node NO12 by filtering out high frequency components from the voltage at the second switching node SN12. A second indictor current IL12 may flow to the second output node NO12 from the second inductor IL12.

The converting circuit 540 may be connected between the voltage node VN and the ground node GN and may include a third power transistor 541, a seventh power transistor 543, a third inductor L13 and a third capacitor C13. The converting circuit 540 may generate a third output voltage Vout13 at a third output node NO13 by converting the input voltage VIN based on a driving signal DS31 and a driving signal DS32. A voltage level of the third output voltage Vout13 may be smaller than a voltage level of the input voltage VIN.

The third power transistor 541 may be coupled between the input voltage VIN and a third switching node SN13, and may have a gate receiving the driving signal DS31. The seventh power transistor 543 may be coupled between the third switching node SN13 and the ground voltage VSS, and may have a gate receiving the driving signal DS32. The third inductor L13 may be coupled between the third switching node SN13 and the third output node NO13, and the third capacitor C13 may be coupled between the third output node NO13 and the ground voltage VSS.

The third power transistor 541 may be turned-on and pull-up the third switching node SN13 in response to the driving signal DS31 being activated with a logic high level. The seventh power transistor 543 may be turned-on and pull-down the third switching node SN13 in response to the driving signal DS32 being activated with a logic high level.

The third inductor L13 and the third capacitor C13 may operate as a low pass filter and may output the third output voltage Vout13 at the third output node NO13 by filtering out high frequency components from the voltage at the third switching node SN13. A third indictor current IL13 may flow to the third output node NO13 from the third inductor L13.

The converting circuit 550 may be connected between the voltage node VN and the ground node GN and may include a fourth power transistor 551, an eighth power transistor 553, a fourth inductor L14 and a fourth capacitor C14. The converting circuit 550 may generate a fourth output voltage Vout14 at a fourth output node NO14 by converting the input voltage VIN based on a driving signal DS41 and a driving signal DS42. A voltage level of the fourth output voltage Vout14 may be smaller than a voltage level of the input voltage VIN.

The fourth power transistor 551 may be coupled between the input voltage VIN and a fourth switching node SN14, and may have a gate receiving the driving signal DS41. The eighth power transistor 553 may be coupled between the fourth switching node SN14 and the ground voltage VSS, and may have a gate receiving the driving signal DS42. The fourth inductor L14 may be coupled between the fourth switching node SN14 and the fourth output node NO14 and the fourth capacitor C14 may be coupled between the fourth output node NO14 and the ground voltage VSS.

The fourth power transistor 551 may be turned-on and pull-up the fourth switching node SN14 in response to the driving signal DS41 being activated with a logic high level. The eighth power transistor 553 may be turned-on and pull-down the fourth switching node SN14 in response to the driving signal DS42 being activated with a logic high level.

The fourth inductor L14 and the fourth capacitor C14 may operate as a low pass filter and may output the fourth output voltage Vout14 at the fourth output node NO14 by filtering out high frequency components from the voltage at the fourth switching node SN14. A fourth indictor current IL14 may flow to the fourth output node NO14 from the fourth inductor L14.

The control circuit 560 may receive the output voltages Vout11, Vout12, Vout13 and Vout14 and reference voltages VREF1, VREF2, VREF3 and VREF4, may generate internal driving signals IDS11 and IDS12 based on comparing the output voltage Vout11 with the reference voltage VREF1, may generate internal driving signals IDS21 and IDS22 based on comparing the output voltage Vout12 with the reference voltage VREF2, may generate internal driving signals IDS31 and IDS32 based on comparing the output voltage Vout13 with the reference voltage VREF3, and may generate internal driving signals IDS41 and IDS42 based on comparing the output voltage Vout14 with the reference voltage VREF4. The control circuit 560 may provide the internal driving signals IDS11 and IDS12 to the driving circuit 510a, may provide the internal driving signals IDS21 and IDS22 to the driving circuit 510b, may provide the internal driving signals IDS31 and IDS32 to the driving circuit 510c, may provide the internal driving signals IDS41 and IDS42 to the driving circuit 510d, and may provide the internal driving signals IDS11, IDS21, IDS31 and IDS41 to the SAS generator 570. The internal driving signals IDS11, IDS21, IDS31 and IDS41 may be high-side internal driving signals.

The SAS generator 570 may receive the high-side internal driving signals IDS11, IDS21, IDS31 and IDS41, may monitor a transition timing of each of the high-side internal driving signals IDS11, IDS21, IDS31 and IDS41, may generate a strength adjusting signal SAS11 transitioning to a logic low level based on the transition timing of the internal driving signal IDS11 being simultaneous with the transition timing of the second internal driving signal IDS31, may generate a strength adjusting signal SAS12 transitioning to a logic low level based on the transition timing of the internal driving signal IDS21 being simultaneous with the transition timing of the second internal driving signal IDS41, and may provide the strength adjusting signal SAS11 to the driving circuits 510a and 510c associated with the internal driving signals IDS11 and IDS13 and may provide strength adjusting signal SAS12 to the driving circuits 510b and 510d.

The driving circuit (e.g., a first driving circuit) 510a may generate the driving signals DS11 and DS12 based on the internal driving signals IDS11 and IDS12, and may selectively reduce a driving strength of the first power transistor 521 based on the strength adjusting signal SAS11 and the internal driving signal IDS11. The driving circuit (e.g., a second driving circuit) 510c may generate the driving signals DS31 and DS32 based on the internal driving signals IDS31 and IDS32, and may selectively reduce a driving strength of the third power transistor 541 based on the strength adjusting signal SAS11 and the internal driving signal IDS31.

The driving circuit 510b may generate the driving signals DS21 and DS22 based on the internal driving signals IDS21 and IDS22, and may maintain normal driving strength of the second power transistor 531 based on the strength adjusting signal SAS12 and the internal driving signal IDS21. The driving circuit 510d may generate the driving signals DS41 and DS42 based on the internal driving signals IDS41 and IDS42, and may maintain normal driving strength of the fourth power transistor 551 based on the strength adjusting signal SAS12 and the internal driving signal IDS41.

Therefore, when the first transition timing of the internal driving signal IDS11 is simultaneous with the second transition timing of the internal driving signal IDS21 and the first power transistor 521 and the second power transistor 531 are simultaneously turned-on or simultaneously turned-off, each driving strength of the first power transistor 521 and the second power transistor 531 which is driven by each of the driving signal DS11 and the driving signal DS21 may be reduced. Accordingly, a ground noise generated at a ground node coupled to the ground voltage VSS of the multi-output voltage converter 500 may be reduced, leading to overall reduction in switching loss of the multi-output voltage converter.

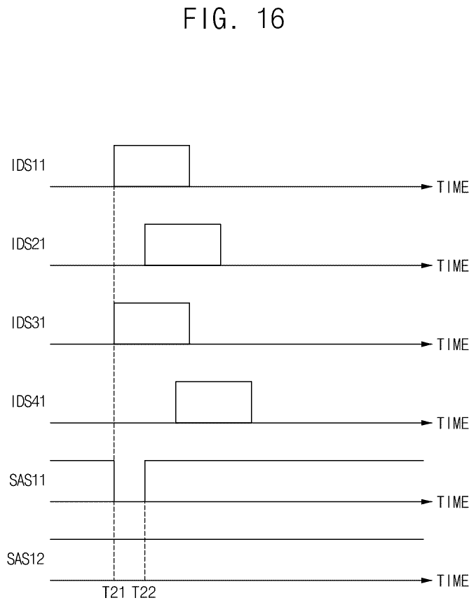

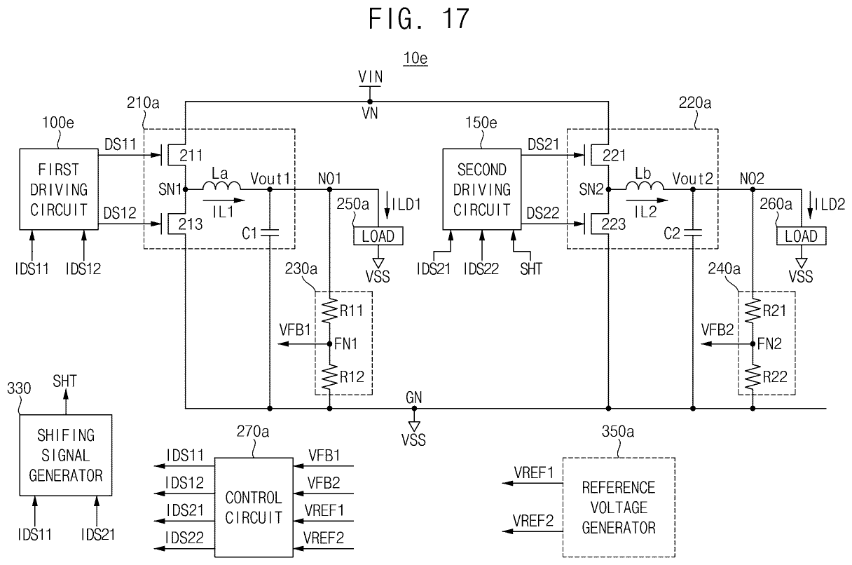

FIG. 16 is a timing diagram illustrating an example operation of the multi-output voltage converter of FIG. 15 according to example embodiments.

Referring to FIGS. 15 and 16, when an activation timing of the internal driving signal IDS11 is simultaneous with an activation timing of the internal driving signal IDS31 at a time point T21, the strength adjusting signal SAS11 has a logic low level between the time point T21 and a time point T22, each driving strength of the first power transistor 521 and the second power transistor 531 is reduced based on the strength adjusting signal SAS11. In addition, because the strength adjusting signal SAS12 is maintained with a logic high level, each driving strength of the second power transistor 531 and the fourth power transistor 551 may be maintained.

FIG. 17 is a block diagram illustrating an example of a multi-output voltage converter according to example embodiments.

In FIG. 17, descriptions repeated with FIG. 1 will be omitted for convenience of explanation.

Referring to FIG. 17, a multi-output voltage converter 10e may include a first driving circuit 100e, a second driving circuit 150e, a first converting circuit 210e, a second converting circuit 220e, a first feedback circuit 230a, a second feedback circuit 240a, a control circuit 270a and a shifting signal generator 330. The multi-output voltage converter 10e may further include a reference voltage generator 350a.

The multi-output voltage converter 10e of FIG. 17 differs from the multi-output voltage converter 10a of FIG. 1 in that the multi-output voltage converter 10e includes the shifting signal generator 330 instead of the SAS generator 300a. Therefore, there will be descriptions on the shifting signal generator 330 and descriptions on other components will be omitted.

The shifting signal generator 330 may receive the first internal driving signal IDS11 and the second internal driving signal IDS21, may monitor a first transition timing of the first internal driving signal IDS11 and a second transition timing of the second internal driving signal IDS21, may generate a shifting signal SHT based on the first transition timing of the first internal driving signal IDS11 being simultaneous with the second transition timing of the second internal driving signal IDS21 and may provide the shifting signal SHT to the first driving circuit 100e or the second driving circuit 150e. In FIG. 17, it is explained as the shifting signal generator 330 provides the shifting signal SHT to the second driving circuit 150e.

The first driving circuit 100e may generate the first driving signal DS11 based on the first internal driving signal IDS11 and may generate the third driving signal DS12 based on the third internal driving signal IDS12.

The second driving circuit 150e may generate the second driving signal DS21 based on the second internal driving signal IDS21, may generate the fourth driving signal DS22 based on the fourth internal driving signal IDS22, and the transition timing of the second internal driving signal IDS21 may not be simultaneous with the transition timing of the first internal driving signal IDS11 by delaying the transition timing of the second internal driving signal IDS21 based on the shifting signal SHT and the second internal driving signal IDS21.

Therefore, when the first transition timing of the first internal driving signal IDS11 is simultaneous with the second transition timing of the second internal driving signal IDS21, the first power transistor 211 and the second power transistor 221 may not be simultaneously turned-on or may not be simultaneously turned-off, because the transition timing of the second driving signal DS21 is delayed from the transition timing of the first driving signal DS11 by the shifting signal SHT. Accordingly, a ground noise generated at the ground node GN of the multi-output voltage converter 10e may be reduced, leading to overall reduction in switching loss of the multi-output voltage converter.

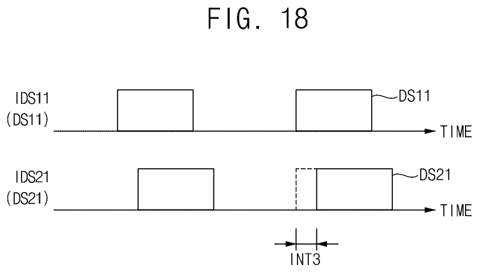

FIG. 18 is a timing diagram illustrating an example operation of the multi-output voltage converter of FIG. 17 according to example embodiments.

Referring to FIGS. 17 and 18, when the activation timing of the first internal driving signal IDS11 is simultaneous with the activation timing of the second internal driving signal IDS21, the activation timing of the second driving signal DS21 may not be simultaneous with the activation timing of the first driving signal DS11 by delaying the activation timing of the second driving signal DS21 by a third time interval INT3 based on the shifting signal SHT.

In FIG. 18, it is shown that the activation timing of the first internal driving signal IDS11 is simultaneous with the activation timing of the second internal driving signal IDS21. In example embodiments, when the deactivation timing of the first internal driving signal IDS11 is simultaneous with the deactivation timing of the second internal driving signal IDS21, the deactivation timing of the second driving signal DS21 may not be simultaneous with the deactivation timing of the first driving signal DS11 by delaying the deactivation timing of the second driving signal DS21 by the third time interval INT3 based on the shifting signal SHT.

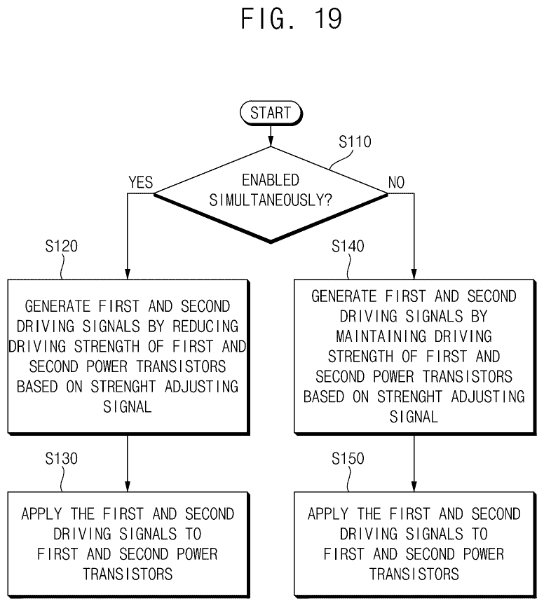

FIG. 19 is a flow chart illustrating a method of operating a multi-output voltage converter according to example embodiments.

Referring to FIGS. 1 through 10 and 19, there is provided a method of operating a multi-output voltage converter 10a that includes a first driving circuit 100a, a second driving circuit 150a, a first converting circuit 210a, a second converting circuit 220a, and an SAS generator 300a. According to the method, the SAS generator 300a determines whether the first internal driving signal IDS11 and the second internal driving signal IDS21 are simultaneously activated (e.g., enabled) (operation S110).

When the first internal driving signal IDS11 and the second internal driving signal IDS21 are simultaneously activated (YES in operation S110), each of the first driving circuit 100a and the second driving circuit 150a generates respective one of the first driving signal DS11 and the second driving signal DS21 and reduces a driving strength of respective one of the first power transistor 211 and the second power transistor 221 based on the strength adjusting signal SAS (operation S120). Each of the first driving circuit 100a and the second driving circuit 150a applies respective one of the first driving signal DS11 and the second driving signal DS21 to respective one of the first and second power transistors 211 and 221 of the first converting circuit 210a and the second converting circuit 220a (operation S130).

When the first internal driving signal IDS11 and the second internal driving signal IDS21 are not simultaneously activated (NO in operation S110), each of the first driving circuit 100a and the second driving circuit 150a generates respective one of the first driving signal DS11 and the second driving signal DS21 and maintains a driving strength of a respective one of the first power transistor 211 and the second power transistor 221a based on the strength adjusting signal SAS (operation S140). Each of the first driving circuit 100a and the second driving circuit 150a applies respective one of the first driving signal DS11 and the second driving signal DS21 to respective one of the first and second power transistors 211 and 221 of the first converting circuit 210a and the second converting circuit 220a (operation S150).

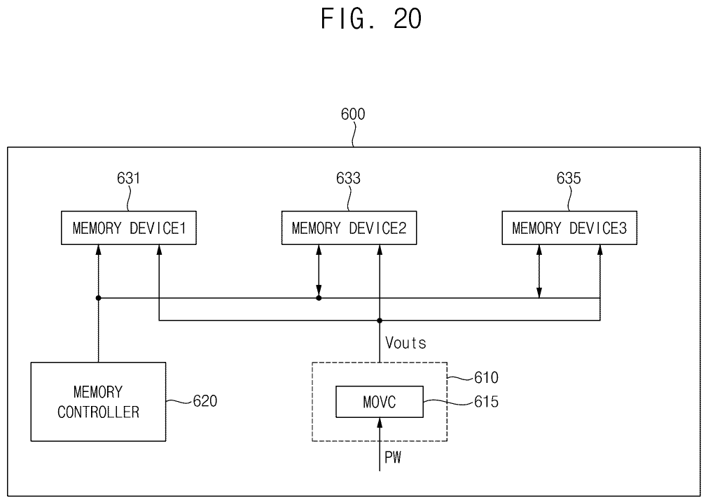

FIG. 20 is a block diagram illustrating an electronic device including a multi-output voltage converter according to example embodiments.

Referring to FIG. 20, an electronic device 600 includes a power management integrated circuit (PMIC) 610 including a multi-output voltage converter MOVC 615, a memory controller 620, and a plurality of memory devices 631, 633, and 635 (memory device1 531, memory device2 533, and memory device3 535). The electronic device 600 may be an SSD for server or a memory module.

The multi-output voltage converter 615 may generate a plurality of output voltages Vouts based on a DC voltage PW received from an outside, and may provide the plurality of output voltages Vouts to the plurality of memory devices 631, 633, and 635. The memory controller 620 may control the plurality of memory devices 631, 633, and 635 and may exchange data with the plurality of memory devices 631, 633, and 635.

Each of the plurality of memory devices 631, 633, and 635 may be a volatile memory device or a nonvolatile memory device. For example, the volatile memory device may be a dynamic random access memory (DRAM) and the nonvolatile memory device may be a flash memory device.

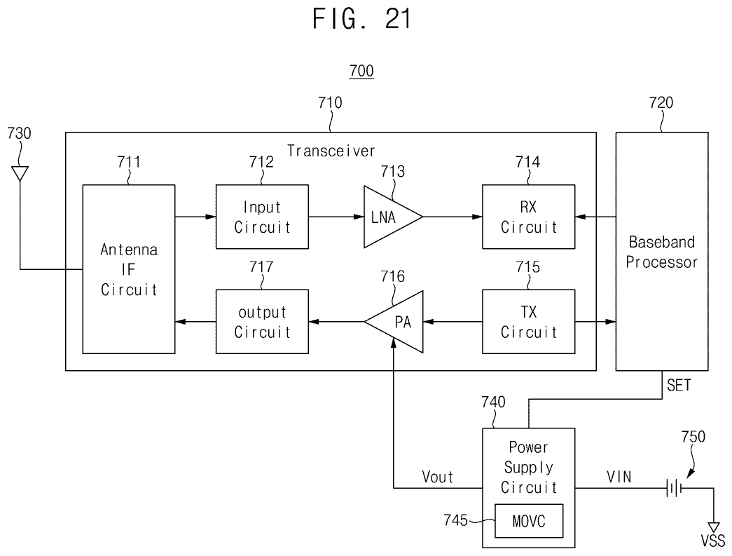

FIG. 21 is a block diagram illustrating a wireless communication device according to example embodiments.

Referring to FIG. 21, a wireless communication device 700 shows a user equipment (UE) (or terminal) to which power is supplied by a battery 750. The wireless communication device 700 may, in some example embodiments, be included in a wireless communication system using a cellular network such as fifth generation (5G) communication system, long-term evolution (LTE) communication system, or may be included in a wireless local area network (WLAN) or any other wireless communication system. In a wireless communication device 700, a multi-output voltage converter MOVC 745 according to example embodiments may be used to provide variable power to a power amplifier 716.

As illustrated in FIG. 21, the wireless communication device 700 may include a transceiver 710, a baseband processor 720, an antenna 730, a power supply circuit 740, and a battery 750.

The transceiver 710 may include an antenna interface circuit 711, an input circuit 712, a low noise amplifier (LNA) 713, a reception (RX) circuit 714, a transmission (TX) circuit 715, a power amplifier (PA) 716 and an output circuit 717. The antenna interface circuit 711 may couple the transmitter or the receiver with the antenna 730 according to a transmission mode or a reception mode. In some example embodiments, the input circuit 712 may include a matching circuit or filter, the low noise amplifier 713 may amplify an output signal of the input circuit 712, and the RX circuit 714 may include a mixer for down-conversion. In some example embodiments, the TX circuit 715 may include a mixer for up-conversion, the power amplifier 716 may amplify an output signal of the TX circuit 715, and the output circuit 717 may include a matching circuit or a filter.

The baseband processor 720 may transmit and receive signals of the baseband with the transceiver 710, and may perform modulation/demodulation, encoding/decoding, and the like. In some example embodiments, the baseband processor 720 may be referred to as a modem. The baseband processor 720 may generate a set signal SET for setting the average power tracking mode or the envelope tracking mode and may generate a set signal SET for changing the level of the output voltage Vout.

The power supply circuit 740 may receive the input voltage VIN from the battery 750 and may generate the output voltage Vout that provides power to the power amplifier 716. The power supply circuit 740 may include the multi-output voltage converter 745.

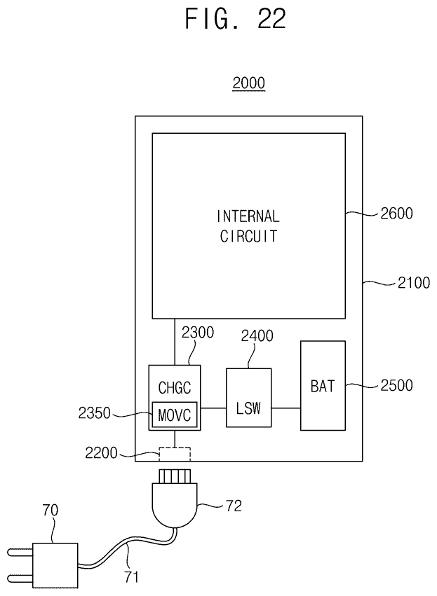

FIG. 22 is a diagram illustrating a system including a multi-output voltage converter according to example embodiments.

Referring to FIG. 22, a system 2000 may include a mobile device 2100 such as a smartphone and an AC-DC wall adaptor or a travel adaptor 70 to supply power to the mobile device 2100. The travel adaptor 70 may be connected to a connector 2200 of the mobile device 2100 through a cable 71 and a jack 72 to supply power to the mobile device 2100.

The mobile device 2100 may include a charging control circuit CHGC 2300, load switch circuit LSW 2400, a battery BAT 2500 and an internal circuit 2600.

The charging control circuit 2300 may change the DC voltage from the travel adaptor 70 to provide charging power to the battery 2500 and/or operating power to the internal circuit 2600. When the travel adaptor 70 is removed, the charged power in the battery may be provided to the internal circuit 2600.

The charging control circuit 2300 may include a multi-output voltage converter MOVC 2350 according to example embodiments as described above. The multi-output voltage converter 2350 may provide an output voltage to the internal circuit 2600. Based on high-side switches that are simultaneously turned-on or turned-off, the multi-output voltage converter 2350 reduces a driving strength of driving signals applied to the high-side switches and thus may reduce ground noise generated at a ground node and may reduce switching loss.

In FIGS. 20, 21 land 22, there are provided descriptions on various applications that employ the multi-output voltage converter according to example embodiments. The multi-output voltage converter, according to example embodiments, may be employed in any electronic devices and systems requiring voltage conversion.

The present disclosure may be applied to any electronic devices and systems requiring voltage conversion. For example, the present disclosure may be applied to systems such as be a memory card, a solid state drive (SSD), an embedded multimedia card (eMMC), a mobile phone, a smart phone, a personal digital assistant (PDA), a portable multimedia player (PMP), a digital camera, a camcorder, a personal computer (PC), a server computer, a workstation, a laptop computer, a digital TV, a set-top box, a portable game console, a navigation system, a wearable device, an internet of things (IoT) device, an internet of everything (IoE) device, an e-book, a virtual reality (VR) device, an augmented reality (AR) device, etc.

While the present disclosure has been particularly shown and described with reference to the example embodiments thereof, it will be understood by those of ordinary skill in the art that various changes in form and detail may be made therein without departing from the spirit and scope of the present disclosure as defined by the following claims.

What is claimed is:

1. A multi-output voltage converter comprising:
a first converting circuit configured to generate a first output voltage by converting an input voltage, the first converting circuit including a first power transistor configured to pull-up a first switching node based on a first driving signal;
a second converting circuit configured to generate a second output voltage by converting the input voltage, the second converting circuit including a second power transistor configured to pull-up a second switching node based on a second driving signal;
a strength adjusting signal generator configured to generate a strength adjusting signal based on a first transition timing of a first internal driving signal and a second transition timing of a second internal driving signal;
a first driving circuit configured to generate the first driving signal which dynamically adjusts a driving strength of the first power transistor based on the strength adjusting signal and the first internal driving signal; and
a second driving circuit configured to generate the second driving signal which dynamically adjusts a driving strength of the second power transistor based on the strength adjusting signal and the second internal driving signal,
wherein the strength adjusting signal indicates that the second transition timing of the second internal driving signal is simultaneous with the first transition timing of the first internal driving signal.

2. The multi-output voltage converter of claim 1, wherein the strength adjusting signal generator is configured to:
generate a first latched signal with a first duration in response to activating of the first internal driving signal;
generate a second latched signal with a second duration in response to activating of the second internal driving signal, wherein the second duration is substantially equal to the first duration; and
generate the strength adjusting signal at a first logic level for a third duration wherein the third duration is defined according to an overlapping period between the first duration of the first latched signal and second duration of the second latched signal.

3. The multi-output voltage converter of claim 2, wherein the third duration is dynamically changed based on a temporal proximity between the first transition timing of the first internal driving signal and the second transition timing of the second internal driving signal.

4. The multi-output voltage converter of claim 3, wherein the strength adjusting signal generator includes:
a first flip-flop including a first set terminal receiving the first internal driving signal, a first output terminal outputting the first latched signal generated by latching the first internal driving signal, and a first reset terminal receiving a first delayed latched signal;
a first timer configured to generate the first delayed latched signal by delaying the first latched signal by a first time delay;
a second flip-flop including a second set terminal receiving the second internal driving signal, a second output terminal outputting a second latched signal generated by latching the second internal driving signal and a second reset terminal receiving a second delayed latched signal;
a second timer configured to generate the second delayed latched signal by delaying the second latched signal by a second time delay; and
a NAND gate configured to generate the strength adjusting signal by performing a NAND operation on the first latched signal and the second latched signal.

5. The multi-output voltage converter of claim 4, wherein the NAND gate is configured to generate the strength adjusting signal at the first logic level for the third duration based on the first duration of the first latched signal and the second duration of the second latched signal.

6. The multi-output voltage converter of claim 4, wherein the first and second time delays are set based on an estimation of power supply noise generated when the first power transistor and the second power transistor are simultaneously turned-on or simultaneously turned-off.

7. The multi-output voltage converter of claim 1, wherein the first driving circuit includes:
a first inverter configured to generate a first inverted internal driving signal by inverting the first internal driving signal;
a logic circuit configured to generate a first control signal and a second control signal based on the first inverted internal driving signal and the strength adjusting signal; and
a gate driver configured to generate the first driving signal based on the first inverted internal driving signal, the first control signal, and the second control signal, and to adjust the driving strength of the first power transistor by controlling a slope of the first driving signal.

8. The multi-output voltage converter of claim 7, wherein the gate driver comprises a first driver and a second driver, wherein the first driver is configured to operate based on the first internal driving signal, and the second driver is configured to operate based on the first internal driving signal, the first control signal and the second control signal.

9. The multi-output voltage converter of claim 8, wherein the logic circuit includes:
a second inverter configured to invert the strength adjusting signal;
an OR gate configured to generate the first control signal by performing an OR operation on the first inverted internal driving signal and an output of the second inverter; and
an AND gate configured to generate the second control signal by performing an AND operation on the first inverted internal driving signal and the strength adjusting signal.

10. The multi-output voltage converter of claim 9, wherein, in response to the strength adjusting signal having a first logic level, the OR gate is configured to output the first control signal at a second logic level and the AND gate is configured to output the second control signal at the first logic level, thereby deactivating the second driver, and reducing the driving strength of the first power transistor, and in response to the strength adjusting signal having the second logic level, the OR gate is configured to output the first control signal at the same logic level as the logic level of the first inverted internal driving signal, and the AND gate is configured to output the second control signal at the same logic level as the logic level of the first inverted internal driving signal, thereby activating the second driver and maintaining the driving strength of the first power transistor.

11. The multi-output voltage converter of claim 8, wherein the first driver includes first p-channel metal-oxide semiconductor (PMOS) transistor which is connected between a power supply voltage and a first node, and has a gate receiving the first inverted internal driving signal, and a first n-channel metal-oxide semiconductor (NMOS) transistor which is connected between the first node and a ground voltage, and has a gate receiving the first inverted internal driving signal, and the second driver includes a second PMOS transistor which is connected between the power supply voltage and the first node in parallel with the first PMOS transistor, and has a gate receiving the first control signal, and a second NMOS transistor which is connected between the first node and the ground voltage in parallel with the first NMOS transistor, and has a gate receiving the second control signal.

12. The multi-output voltage converter of claim 11, wherein the gate driver, in response to the strength adjusting signal at a logic low level, is configured to reduce the driving strength of the first power transistor by deactivating the second PMOS transistor via the first control signal at a logic high level and by deactivating the second NMOS transistor via the second control signal at the logic low level.

13. The multi-output voltage converter of claim 11, wherein the gate driver, in response to the strength adjusting signal at a logic high level, is configured to maintain the driving strength of the first power transistor by activating the second PMOS transistor and the second NMOS transistor such that each logic level of the first control signal and the second control signal is the same as the logic level of the first internal driving signal.

14. The multi-output voltage converter of claim 1,
wherein the first converting circuit includes a third power transistor which is connected between the first switching node and a ground voltage and is configured to pull-down the first switching node based on a third driving signal,
wherein the second converting circuit further includes a fourth power transistor which is connected between the second switching node and the ground voltage and is configured to pull-down the second switching node based on a fourth driving signal.

15. The multi-output voltage converter of claim 14,
wherein the first driving circuit is configured to generate the third driving signal by buffering a third internal driving signal, and
wherein the second driving circuit is configured to generate the fourth driving signal by buffering a fourth internal driving signal.

16. The multi-output voltage converter of claim 1, further comprising a control circuit, wherein the control circuit is configured to:
generate the first internal driving signal based on a first reference voltage and a first feedback voltage proportional to the first output voltage; and
generate the second internal driving signal based on a second reference voltage and a second feedback voltage proportional to the second output voltage.

17. The multi-output voltage converter of claim 1, wherein each of the first converting circuit and the second converting circuit corresponds to one of a buck converter, a boost converter and a buck-boost converter.

18. A multi-output voltage converter comprising:
a plurality of converting circuits, each of the plurality of converting circuits including a inductor and a power transistor and configured to generate a output voltage at a respective output node by converting an input voltage based on a respective driving signal, each power transistor of the plurality of converting circuits configured to pull-up a respective switching node based on the respective driving signal, each switching node of the plurality of converting circuits being coupled to a first end of the respective inductor;
a strength adjusting signal generator configured to generate a plurality of strength adjusting signals based on transition timings of a plurality of internal driving signals including a first internal driving signal and a second internal driving signal; and
a plurality of driving circuits including a first driving circuit and a second driving circuit, the first and second driving circuits configured to generate a first driving signal and a second driving signal based on a first internal driving signal and a second internal driving signal, wherein the first driving signal drives a first power transistor and the second driving signal drives a second power transistor,
wherein, upon detecting that a first transition timing of the first internal driving signal is simultaneous with a second transition timing of the second internal driving signal, each of the first driving circuit associated with a first driving signal and the second driving circuit associated with a second driving signal is configured to reduce a driving strength of a respective one of the first power transistor and the second power transistor, based on the first internal driving signal, the second internal driving signal and a first strength adjusting signal indicating that the first transition timing is simultaneous with the second transition timing.

19. The multi-output voltage converter of claim 18, wherein driving circuits other than the first and the second driving circuits among the plurality of driving circuits are configured to maintain driving strength of corresponding power transistors based on a second strength adjusting signal indicating that the transition timings of the internal driving signals other than the first and second driving signals are not simultaneous.

20. A multi-output voltage converter comprising:
a first converting circuit including a first inductor and a first power transistor, the first converting circuit configured to generate a first output voltage at a first output node by converting an input voltage based on a first driving signal, the first power transistor configured to pull-up a first switching node coupled to a first end of the first inductor based on the first driving signal;
a second converting circuit including a second inductor and a second power transistor, the second converting circuit configured to generate a second output voltage at a second output node by converting the input voltage based on a second driving signal, the second power transistor configured to pull-up a second switching node coupled to a first end of the second inductor based on the second driving signal;
a shifting signal generator configured to generate a shifting signal based on a first transition timing of a first internal driving signal and a second transition timing of a second internal driving signal;
a first driving circuit configured to generate the first driving signal based on the first internal driving signal; and
a second driving circuit configured to generate the second driving signal by shifting the second transition timing of the second internal driving signal based on the shifting signal indicating that the first transition timing is simultaneous with the second transition timing.
